(19) United States
(12) Patent Application Publication
(10) Pub. No.: US 2024/0270591 A1
(43) Pub. Date: Aug. 15, 2024

(54) LITHIUM RECOVERY AND PURIFICATION

(71) Applicants: XPS EXPERT PROCESS SOLUTIONS - GLENCORE CANADA CORPORATION, Falconbridge (CA); AG HYDROMETALLURGY SERVICES INC., Kingston (CA); FRONTIER LITHIUM INC., Val Caron (CA)

(72) Inventors: Ahmad GHAHREMAN, Kingston (CA); Gregg HILL, Sudbury (CA); Mika MUINONEN, Sudbury (CA)

(21) Appl. No.: 18/569,039

(22) PCT Filed: Jun. 11, 2021
(86) PCT No.: PCT/CA2021/050797

§ 371 Date: Dec. 11, 2023

(51) Int. Cl. C01D 15/04; C01F 11/46; C22B 7/00; H01M 10/54

(52) U.S. Cl. CPC C01D 15/04; C01F 11/462; C22B 7/007; H01M 10/54

(57) ABSTRACT

A process for recovering lithium chloride from a lithium sulfate (Li₂SO₄)-containing mixture is described, comprising a step of sulfate removal using barium chloride (BaCl₂). In embodiments, the process may further comprise one or more steps to reduce the level of one or more metals other than lithium and to reduce the level of sulfate by increasing the pH of the (Li₂SO₄)-containing mixture, e.g., using a calcium salt. In embodiments, treatments to reduce the level of one or more metals other than lithium, sulfate, and other components (e.g., calcium if used) may be used, producing a solution substantially comprising Li₂SO₄ for barium chloride (BaCl₂) treatment, to form a precipitate comprising barium sulfate (BaSO₄) and a solution substantially comprising lithium chloride.

### FIELD OF THE DISCLOSURE

This disclosure relates to the field of metallurgy. More specifically, the present disclosure broadly relates to the recovery and purification of metal species. In particular, but not exclusively, the present disclosure relates to the recovery and/or purification of lithium (Li) species from various sources. In particular, but not exclusively, the present disclosure relates to a process for recovering lithium chloride from various sources.

### BACKGROUND OF THE DISCLOSURE

The demand for lithium metal has increased exponentially over the years as it is used in various materials, including ceramic glass, adhesive, lubricants, metal alloys, and in particular electrode materials for lithium-ion batteries. Lithium is present in several natural resources including ores, clays, brines and sea water, and may be extracted therefrom. Also, it has become more and more important to recover lithium from electrode material of recycled batteries. Processes for lithium extraction/recovery are known in the art and include for example pyrometallurgical and hydrometallurgical processes, the latter including for example leaching, solvent extraction, ion exchange and precipitation (reviewed in for example Nguyen TH and Lee MS (2018), Processes 55: 1-15). Drawbacks include for example issues of efficiency, level of purity obtained, scale and cost. Novel processes for lithium recovery and/or purification are of commercial interest.

### SUMMARY OF THE DISCLOSURE

The present disclosure broadly relates to the recovery and purification of metal species. In particular, but not exclusively, the present disclosure relates to the recovery and/or purification of lithium species from various sources. In particular, but not exclusively, the present disclosure relates to a process for recovering lithium chloride from various sources. In an aspect, the present disclosure relates to the design and study of processes for recovering lithium chloride from a material comprising a lithium species.

Also disclosed within the context of the present disclosure are embodiments 1-88.

Embodiment 1 is a process for recovering lithium chloride from an initial aqueous solution comprising lithium sulfate (Li₂SO₄), the process comprising: increasing the pH of the initial Li₂SO₄-comprising aqueous solution to reduce the level of species of one or more metals other than lithium and to remove sulfate; treating the solution after the reducing of the one or more metals other than lithium and the removal of sulfate with a material to remove calcium and to produce a solution substantially comprising Li₂SO₄; treating the solution substantially comprising Li₂SO₄ with barium chloride (BaCl₂) to form a precipitate comprising barium sulfate (BaSO₄) and a solution substantially comprising lithium chloride; and recovering the lithium chloride (LiCl) from the solution following BaSO₄ precipitation; wherein the aqueous solution comprising lithium sulfate (Li₂SO₄) is derived from a natural source or mineral deposit comprising a lithium species or from a synthetic or non-natural source comprising a lithium species.

Embodiment 2 is the process of embodiment 1, wherein the lithium chloride is recovered in the form of lithium chloride or a hydrate thereof.

Embodiment 3 is the process of embodiment 1 or 2, wherein the initial aqueous solution comprising lithium sulfate is derived from a natural source or mineral deposit comprising a lithium species.

Embodiment 4 is the process of any one of embodiments 1 to 3, wherein the natural source or mineral deposit comprising the lithium species is an ore, clay or brine.

Embodiment 5 is the process of any one of embodiments 1 to 4, wherein the natural source or mineral deposit comprising the lithium species is not a sulfide ore body.

Embodiment 6 is the process of embodiment 4 or 5, wherein the ore or clay comprises lepidolite, hectorite, jaderite, spodumene, petalite and/or amblygonite.

Embodiment 7 is the process of embodiment 4 or 5, wherein the brine comprises continental brine, geothermal brine and/or oilfield brine.

Embodiment 8 is the process of embodiment 1 or 2, wherein the aqueous solution comprising lithium sulfate is derived from a synthetic or non-natural source comprising a lithium species.

Embodiment 9 is the process of embodiment 8, wherein the synthetic or non-natural source comprising the lithium species comprises materials produced during recycling of lithium-ion batteries or other lithium bearing materials.

Embodiment 10 is the process of embodiment 9, wherein the materials produced during recycling of lithium-ion batteries comprise lithium-ion battery electrode materials.

Embodiment 11 is the process of embodiment 9 or 10, wherein the materials produced during recycling of lithium-ion batteries and/or lithium-ion battery electrode materials comprise lithium cobalt oxide, lithium manganese oxide, lithium iron phosphate, and/or lithium nickel manganese cobalt oxide.

Embodiment 12 is the process of any one of embodiments 1 to 11, further comprising producing the initial Li₂SO₄-comprising aqueous solution via treatment of a metal-comprising mixture with sulfuric acid (H₂SO₄).

Embodiment 13 is the process of embodiment 12, wherein the metal-comprising mixture is the natural source or mineral deposit comprising the lithium species or the synthetic or non-natural source comprising the lithium species, or is a derivative of the natural source or mineral deposit comprising the lithium species or the synthetic or non-natural source comprising the lithium species.

Embodiment 14 is the process of embodiment 12 or 13, wherein the metal-comprising mixture comprises lithium oxide (Li₂O).

Embodiment 15 is the process of any one of embodiments 1 to 14, wherein the initial Li₂SO₄-comprising aqueous solution has a pH of about 4.0 or less.

Embodiment 16 is the process of embodiment 15, wherein the initial Li₂SO₄-comprising aqueous solution has a pH of about 2.0 to about 3.0.

Embodiment 17 is the process of any one of embodiments 1 to 16, wherein the initial Li₂SO₄-comprising aqueous solution further comprises one or more metal sulfates of one or more metals other than lithium.

Embodiment 18 is the process of any one of embodiments 12 to 17, wherein the metal-comprising mixture further comprises one or more metals other than lithium.

Embodiment 19 is the process of embodiment 17 or 18, wherein the one or more metals other than lithium are one or more of Group I metals (other than lithium), Group Il metals, transition metals and/or post-transition metals.

Embodiment 20 is the process of any one of embodiments 17 to 19, wherein the one or more metals other than lithium are one or more of calcium, sodium, magnesium, potassium, aluminum and iron.

Embodiment 21 is the process of any one of embodiments 1 to 20, wherein the pH of the initial Li₂SO₄-comprising aqueous solution is increased to about 3.0 or higher.

Embodiment 22 is the process of embodiment 21, wherein the pH of the initial Li₂SO₄-comprising aqueous solution is increased to about 4.0 to about 5.5.

Embodiment 23 is the process of embodiment 21 or 22, wherein the pH of the initial Li₂SO₄-comprising aqueous solution is increased to about 7.0 or higher.

Embodiment 24 is the process of embodiment 23, wherein the pH of the initial Li₂SO₄-comprising aqueous solution is increased to be about 9.0 to about 12.0.

Embodiment 25 is the process of any one of embodiments 1 to 24, wherein the reducing the level of species of the one or more metals other than lithium by increasing the pH of the initial Li₂SO₄-comprising aqueous solution is performed in single step.

Embodiment 26 is the process of embodiment 25, wherein the single step comprises increasing the pH of the initial Li₂SO₄-comprising aqueous solution to be about 3.0 or higher.

Embodiment 27 is the process of embodiment 26, wherein the pH of the initial Li₂SO₄-comprising aqueous solution is increased to about 4.0 to about 5.5.

Embodiment 28 is the process of embodiment 25, wherein the single step comprises increasing the pH of the initial Li₂SO₄-comprising aqueous solution to about 7.0 or higher.

Embodiment 29 is the process of embodiment 28, wherein the pH of the initial Li₂SO₄-comprising aqueous solution is increased to about 9.0 to about 12.0.

Embodiment 30 is the process of any one of embodiments 1 to 24, wherein the reducing the level of species of the one or more metals other than lithium by increasing the pH of the initial Li₂SO₄-comprising aqueous solution comprises multiple steps.

Embodiment 31 is the process of embodiment 30, wherein the multiple steps comprise a first step of increasing the pH of the initial Li₂SO₄-comprising aqueous solution to a pH of about 3.0 or higher to produce a first Li₂SO₄-comprising aqueous solution comprising reduced levels of metals other than lithium, followed by increasing the pH of the first Li₂SO₄-comprising aqueous solution to a pH of about 7.0 or higher to produce a second Li₂SO₄-comprising aqueous solution comprising further reduced levels of metals other than lithium.

Embodiment 32 is the process of any one of embodiments 1 to 31, wherein increasing the pH of the initial Li₂SO₄-comprising aqueous solution comprises treating with an alkaline material.

Embodiment 33 is the process of embodiment 32, wherein the alkaline material comprises lime.

Embodiment 34 is the process of embodiment 33, wherein the lime is in the form of a lime slurry or solid lime powder.

Embodiment 35 is the process of any one of embodiments 1 to 34, wherein calcium removal comprises treating with a carbonate source to form a precipitate comprising one or more metal carbonates, wherein the lithium species is recovered from the solution remaining after precipitation of the one or more metal carbonates.

Embodiment 36 is the process of embodiment 35, wherein the carbonate source is a carbonate salt or CO₂ gas.

Embodiment 37 is the process of embodiment 36, wherein the carbonate salt is at least one of sodium carbonate (Na₂CO₃) or lithium carbonate (Li₂CO₃).

Embodiment 38 is the process of any one of embodiments 35 to 37, wherein the one or more metal carbonates are one or more of calcium carbonate and magnesium carbonate.

Embodiment 39 is the process of any one of embodiments 25 to 31, wherein increasing the pH comprises treating the initial Li₂SO₄-comprising aqueous solution with one or more calcium salts.

Embodiment 40 is the process of embodiment 39, wherein the treatment of the Li₂SO₄-comprising aqueous solution with the one or more calcium salts produces a precipitate comprising calcium sulfate (CaSO₄).

Embodiment 41 is the process of embodiment 40, wherein the precipitate further comprises magnesium and/or base metal oxides and/or hydroxides.

Embodiment 42 is the process of any one of embodiments 1 to 41, wherein the treatment with barium chloride to form a precipitate comprising barium sulfate is performed at a pH of about 6.0 or higher.

Embodiment 43 is the process of embodiment 42, wherein the treatment with barium chloride to form a precipitate comprising barium sulfate is performed at a pH of about 9.0 to about 12.0.

Embodiment 44 is the process of any one of embodiments 1 to 43, wherein the barium chloride is added at a molar ratio of barium to sulfate of about 0.1 to about 3.0.

Embodiment 45 is the process of embodiment 44, wherein the barium chloride is added at a molar ratio of barium to sulfate of about 0.8 to about 1.5.

Embodiment 46 is the process of embodiment 45, wherein the barium chloride is added at a molar ratio of barium to sulfate of about 0.95 to about 1.1.

Embodiment 47 is the process of any one of embodiments 1 to 46, wherein the lithium chloride is recovered by crystallization from the aqueous solution.

Embodiment 48 is the process of embodiment 47, comprising at least one of heat treatment or subjecting the aqueous solution to reduced pressure to remove at least a part of the water from the aqueous solution.

Embodiment 49 is the process of embodiment 48, wherein at least about 10% of the water is removed.

Embodiment 50 is the process of embodiment 49, wherein at least about 15% of the water is removed.

Embodiment 51 is the process of any one of embodiments 1 to 50, wherein the recovered lithium species is a hydrate of lithium chloride.

Embodiment 52 is the process of any one of embodiments 1 to 51, further comprising subjecting the BaSO₄ to a treatment to generate barium salts including barium oxide, barium hydroxide or barium carbonate and to recover sulfur as sodium sulfide, sodium hydrosulfide, sulfuric acid, or elemental sulfur.

Embodiment 53 is the process of embodiment 51 or 52, further comprising subjecting SO₃ to water treatment to form H₂SO₄.

Embodiment 54 is the process of embodiment 53, wherein the H₂SO₄ is used for treating the metal-comprising mixture of embodiment 12.

Embodiment 55 is the process of any one of embodiments 1 to 54, wherein the solution substantially comprising Li₂SO₄ is treated with barium chloride at a pH of at least about 6, at least about 7, about 6 to about 12, about 7 to about 12, about 8 to about 12, about 9 to about 12, about 10 to about 12, about 6, about 7, about 8, about 9, about 10, about 11, or about 12.

Embodiment 56 is the process of embodiment 39 or 40, wherein treating with the one or more calcium salts is performed at a pH of at least about 3, at least about 4, at least about 5, at least about 6, at least about 7, about 3 to about 12, about 4 to about 12, about 5 to about 12, about 6 to about 12, about 7 to about 12, about 8 to about 12, about 9 to about 12, about 10 to about 12, about 3, about 4, about 5, about 6, about 7, about 8, about 9, about 10, about 11, or about 12.

Embodiment 57 is the process of embodiment 56, wherein treating with the one or more calcium salts is performed at a molar ratio of calcium to sulfate of about 80% to about 120%, about 90% to about 120%, about 100% to about 120%, about 90% to about 110%, about 80%, about 90%, about 100%, about 110% or about 120%.

Embodiment 58 is the process of any one of embodiments 1 to 57, wherein the solution comprising substantially Li₂SO₄, is treated with barium chloride at a molar ratio of barium to sulfate of about 10% to about 300%, about 80% to about 150%, about 80% to about 120%, about 90% to about 120%, about 100% to about 120%, about 90% to about 110%, about 95% to about 110%, about 80%, about 90%, about 100%, about 110% or about 120%.

Embodiment 59 is the process of any one of embodiments 1 to 58, wherein the solution substantially comprising Li₂SO₄ is treated with barium chloride at a temperature of about 1° C. to about 100° C., about 5° C. to about 75° C., about 5° C. to about 60° C., about 10° C. to about 60° C., about 15° C. to about 60° C., about 20° C. to about 60° C., or at room temperature.

Embodiment 60 is the process of any one of embodiments 35 to 38, wherein the treatment with the carbonate source is performed at a molar ratio of carbonate to the one or more metals of about 80% to about 120%, about 90% to about 120%, about 100% to about 120%, about 90% to about 110%, about 80%, about 90%, about 100%, about 110% or about 120%.

Embodiment 61 is the process of any one of embodiments 1 to 60, wherein the concentration of lithium in the initial aqueous solution comprising lithium sulfate (Li₂SO₄) is about 1 to about 25 g/L, about 5 to about 25 g/L, about 5 to about 20 g/L, about 5 to about 15 g/L, about 8 to about 12 g/L, about 5 g/L, about 6 g/L, about 7 g/L, about 8 g/L, about 9 g/L, about 10 g/L, about 11 g/L, about 12 g/L, about 13 g/L, about 14 g/L, or about 15 g/L.

Embodiment 62 is the process of any one of embodiments 1 to 61, wherein at least about 50%, 55%, 60%, 65%, 70%, 75%, 80%, 90%, 95% or 99% of the lithium is recovered from the initial aqueous solution comprising lithium sulfate.

Embodiment 63 is the process of any one of embodiments 1 to 62, wherein about 50% to about 99%, about 55% to about 99%, about 60% to about 99%, about 65% to about 99%, about 70% to about 99%, about 75% to about 99%, about 80% to about 99%, or about 90% to about 99% of the lithium is recovered from the initial aqueous solution comprising lithium sulfate.

Embodiment 64 is a process for recovering lithium chloride from a material comprising a lithium species and species of one or more metals other than lithium, the process comprising: treating the material with sulfuric acid (H₂SO₄) to provide an initial Li₂SO₄-comprising aqueous solution; increasing the pH of the initial Li₂SO₄-comprising aqueous solution to reduce the level of species of one or more metals other than lithium and to remove sulfate; treating the solution after the reducing of the one or more metals other than lithium and the removal of sulfate with a material to remove calcium and to produce a solution substantially comprising Li₂SO₄; treating the solution substantially comprising Li₂SO₄ with barium chloride to form a precipitate comprising barium sulfate and a solution substantially comprising lithium chloride; and recovering the lithium chloride from the solution remaining following the removal of the barium sulfate comprising precipitate in the form of lithium chloride or a hydrate thereof, via heat treatment and crystallization.

Embodiment 65 is the process of embodiment 64, wherein the reducing the level of species of the one or more metals other than lithium by increasing the pH of the initial Li₂SO₄-comprising aqueous solution is performed in single step.

Embodiment 66 is the process of embodiment 65, wherein the single step comprises increasing the pH of the initial Li₂SO₄-comprising aqueous solution to be about 3.0 or higher.

Embodiment 67 is the process of embodiment 66, wherein the pH of the initial Li₂SO₄-comprising aqueous solution is increased to about 4.0 to about 5.5.

Embodiment 68 is the process of embodiment 67, wherein the single step comprises increasing the pH of the initial Li₂SO₄-comprising aqueous solution to about 7.0 or higher.

Embodiment 69 is the process of embodiment 68, wherein the pH of the initial Li₂SO₄-comprising aqueous solution is increased to about 9.0 to about 12.0.

Embodiment 70 is the process of embodiment 64, wherein the reducing the level of species of the one or more metals other than lithium by increasing the pH of the initial Li₂SO₄-comprising aqueous solution comprises multiple steps.

Embodiment 71 is the process of embodiment 70, wherein the multiple steps comprise a first step of increasing the pH of the initial Li₂SO₄-comprising aqueous solution to a pH of about 3.0 or higher to produce a first Li₂SO₄-comprising aqueous solution comprising reduced levels of metals other than lithium, followed by increasing the pH of the first Li₂SO₄-comprising aqueous solution to a pH of about 7.0 or higher to produce a second Li₂SO₄-comprising aqueous solution comprising further reduced levels of metals other than lithium.

Embodiment 72 is the process of any one of embodiments 64 to 71, wherein increasing the pH of the initial Li₂SO₄-comprising aqueous solution comprises treating with an alkaline material.

Embodiment 73 is the process of embodiment 72, wherein the alkaline material comprises lime.

Embodiment 74 is the process of embodiment 73, wherein the lime is in the form of a lime slurry or solid lime powder.

Embodiment 75 is the process of any one of embodiments 64 to 74, wherein calcium removal comprises treating with a carbonate source to form a precipitate comprising one or more metal carbonates, wherein the lithium species is recovered from the solution remaining after precipitation of the one or more metal carbonates.

Embodiment 76 is the process of embodiment 75, wherein the carbonate source is a carbonate salt or CO₂ gas.

Embodiment 77 is the process of embodiment 76, wherein the carbonate salt is at least one of sodium carbonate (Na₂CO₃) or lithium carbonate (Li₂CO₃).

Embodiment 78 is the process of any one of embodiments 75 to 77, wherein the one or more metal carbonates are one or more of calcium carbonate and magnesium carbonate.

Embodiment 79 is the process of any one of embodiments 64 to 71, wherein increasing the pH comprises treating the initial Li₂SO₄-comprising aqueous solution with one or more calcium salts.

Embodiment 80 is the process of any one of embodiments 64 to 79, wherein the material is obtained from a natural source or mineral deposit comprising lithium species.

Embodiment 81 is the process of embodiment 80, wherein the natural source is an ore, clay, brine or other mineral deposit.

Embodiment 82 is the process of embodiment 81, wherein the ore or clay comprises lepidolite, hectorite, jaderite, spodumene, petalite and/or amblygonite.

Embodiment 83 is the process of any one of embodiments 80 to 82, wherein the natural source or mineral deposit comprising lithium species is not a sulfide ore body.

Embodiment 84 is the process of embodiment 81, wherein the brine comprises continental brine, geothermal brine and/or oilfield brine.

Embodiment 85 is the process of any one of embodiments 64 to 79, wherein the material is obtained from a synthetic or non-natural source comprising lithium species.

Embodiment 86 is the process of embodiment 85, wherein the synthetic or non-natural source comprising lithium species comprises materials produced during recycling of lithium-ion batteries or other lithium bearing materials.

Embodiment 87 is the process of embodiment 86, wherein the materials produced during recycling of lithium-ion batteries comprise lithium-ion battery electrode materials.

Embodiment 88 is the process of embodiment 87, wherein the lithium-ion battery electrode materials comprise lithium cobalt oxide, lithium manganese oxide, lithium iron phosphate, and/or lithium nickel manganese cobalt oxide.

The foregoing and other advantages and features of the present disclosure will become more apparent upon reading of the following non-restrictive detailed description of illustrative embodiments thereof, with reference to the accompanying drawings/figures. It should be understood, however, that the detailed description and the illustrative embodiments, while indicating specific embodiments of the disclosure, are given by way of illustration only, since various changes and modifications within the spirit and scope of the disclosure will become apparent to those skilled in the art from this description.

### BRIEF DESCRIPTION OF THE DRAWINGS/FIGURES

The following figures/drawings form part of the present specification and are included to further demonstrate certain aspects of the present specification. The present specification may be better understood by reference to one or more of these figures/drawings in combination with the detailed description. In the appended drawings/figures:

FIG. 1—Illustration of a flowchart illustrating the process for recovering lithium as LiCl from an Li₂SO₄ containing solution in accordance with an embodiment of the present disclosure.

FIG. 2—Illustration of a flowchart illustrating Al—Fe removal steps in accordance with an embodiment of the present disclosure.

FIG. 3—Illustration of Fe and Al recovery (%) and Li loss (%) at pH=4.75.

FIG. 4—Illustration of an XRD pattern of solid residue from the Al—Fe removal step.

FIG. 5—Illustration of a flowchart illustrating Mg removal steps in accordance with an embodiment of the present disclosure.

FIG. 6—Illustration of sulfate and Mg removal (%) and Li loss (%) at pH=10 and CaO=5% at T=65° C.

FIG. 7—Illustration of an XRD pattern of solid residue from primary sulfate removal step.

FIG. 8—Illustration of a flowchart illustrating Ca removal steps in accordance with an embodiment of the present disclosure.

FIG. 9—Illustration of Ca removal (%) and Li loss (%) in samples at Na₂CO₃/Ca=2 and at room temperature.

FIG. 10—Illustration of a flowchart illustrating BaSO₄ removal steps in accordance with an embodiment of the present disclosure.

FIG. 11—Illustration of an XRD pattern of the BaSO₄ residue following treatment with BaCl₂.

FIG. 12—Titration curve for PLS by 1 M NaOH at room temperature.

FIGS. 13A and 13B—Concentration of the elements in Al—Fe removal step at different pH.

FIG. 14—Concentration of Fe, Al and Li in kinetic samples at pH=4.5 at room temperature

FIG. 15—Fe and Al recovery (%) and Li loss (%) at pH=4.5 at room temperature.

FIG. 16—Concentration of Fe, Al and Li in kinetic samples at pH=5 at room temperature.

FIG. 17—Fe and Al recovery (%) and Li loss (%) at pH=5 at room temperature.

FIG. 18—Effect of time and pH on Li loss at room temperature.

FIG. 19—Concentration of Fe, Al and Li in kinetic samples at pH=4.75 and T=Room T.

FIG. 20—Fe and Al recovery (%) and Li loss (%) at pH=4.75 and T=Room T.

FIG. 21—Concentration of Fe, Al and Li in kinetic samples at pH=4.75 and T=45° C.

FIG. 22—Fe and Al recovery (%) and Li loss (%) at pH=4.75 and T=45° C.

FIG. 23—Concentration of Fe, Al and Li in kinetic samples at pH=4.75 and T=65° C.

FIG. 24—Fe and Al recovery (%) and Li loss (%) at pH=4.75 and T=65° C.

FIG. 25—Concentration of Fe, Al and Li in kinetic samples at pH=4.75 and T=85° C.

FIG. 26—Fe and Al recovery (%) and Li loss (%) at pH=4.75 and T=85° C.

FIG. 27—Effect of time and Temperature on Li loss.

FIG. 28—Concentration of Fe, Al and Li in kinetic samples at pH=4.75 and T=65° C. with 10% CaO.

FIG. 29—Fe and Al recovery (%) and Li loss (%) at pH=4.75 and T=65° C. with 10% CaO.

FIG. 30—Concentration of the elements in kinetic samples at pH=7 and CaO=5% at room temperature.

FIG. 31—Mg and sulfate removal (%) and Li loss (%) at pH=7 and CaO=5% at room temperature.

FIG. 32—Concentration of the elements in kinetic samples at pH=8 and CaO=5% at room temperature.

FIG. 33—Mg and sulfate removal (%) and Li loss (%) at pH=8 and CaO=5% at room temperature.

FIG. 34—Concentration of the elements in kinetic samples at pH=9 and CaO=5% at room temperature.

FIG. 35—Mg and Sulfate removal (%) and Li loss (%) at pH=9 and CaO=5% at room temperature.

FIG. 36—Concentration of the elements in kinetic samples at pH=9.5 and CaO=5% at room temperature.

FIG. 37—Mg and Sulfate removal (%) and Li loss (%) at pH=9.5 and CaO=5% at room temperature.

FIG. 38—Concentration of the elements in kinetic samples at pH=10 and CaO=5% at room temperature.

FIG. 39—Mg and Sulfate removal (%) and Li loss (%) at pH=10 and CaO=5% at room temperature.

FIG. 40—Effect of time and pH on Mg removal at room temperature.

FIG. 41—Concentration of the elements in kinetic samples at pH=10 and CaO=5% at T=45° C.

FIG. 42—Sulfate removal (%) and Li loss (%) at pH=10 and CaO=5% at T=45° C.

FIG. 43—Concentration of the elements in kinetic samples at pH=10 and CaO=5% at T=65° C.

FIG. 44—Mg and Sulfate removal (%) and Li loss (%) at pH=10 and CaO=5% at T=65° C.

FIG. 45—Concentration of the elements in kinetic samples at pH=10 and CaO=5% at T=85° C.

FIG. 46—Mg and Sulfate removal (%) and Li loss (%) at pH=10 and CaO=5% at T=85° C.

FIG. 47—Effect of time and Temperature on Mg removal %.

FIG. 48—Concentration of the elements in kinetic samples at pH=10 and CaO=1% at room T.

FIG. 49—Mg and Sulfate removal (%) and Li loss (%) at pH=10 and CaO=1% at room T.

FIG. 50—Concentration of the elements in kinetic samples at pH=10 and CaO=10% at room T.

FIG. 51—Mg and Sulfate removal (%) and Li loss (%) at pH=10 and CaO=10% at room T.

FIG. 52—Concentration of the elements in kinetic samples in presence of Amberlite IRC-50 at room temperature.

FIG. 53—Ca removal (%) and Li loss (%) in presence of Amberlite IRC-50 at room temperature.

FIG. 54—Concentration of the elements in kinetic samples at CO₂=0.5 L/min and room T.

FIG. 55—Ca removal (%) and Li loss (%) at CO₂=0.5 L/min and room T.

FIG. 56—Concentration of the elements in kinetic samples at CO₂=1.5 L/min and room T.

FIG. 57—Ca removal (%) and Li loss (%) at CO₂=0.5 L/min and room T.

FIG. 58—Concentration of the elements in kinetic samples at Na₂CO₃=0.363 g/250 ml (Na₂CO₃/Ca=0.9) and room T.

FIG. 59—Ca removal (%) and Li loss (%) at samples at Na₂CO₃=0.363 g/250 ml (Na₂CO₃/Ca=0.9) and room T.

FIG. 60—Concentration of the elements in kinetic samples at Na₂CO₃=0.41 g/250 ml (Na₂CO₃/Ca=1.0) and room T.

FIG. 61—Ca removal (%) and Li loss (%) at samples at Na₂CO₃=0.41 g/250 ml (Na₂CO₃/Ca=1.0) and room T.

FIG. 62—Concentration of the elements in kinetic samples at Na₂CO₃=0.485 g/250 ml (Na₂CO₃/Ca=1.2) and room T.

FIG. 63—Ca removal (%) and Li loss (%) at samples at Na₂CO₃=0.485 g/250 mL (Na₂CO₃/Ca=1.2) and room T.

FIG. 64—Concentration of the elements in kinetic samples at Na₂CO₃=0.605 g/250 ml (Na₂CO₃/Ca=1.5) and room T.

FIG. 65—Ca removal (%) and Li loss (%) at samples at Na₂CO₃=0.605 g/250 ml (Na₂CO₃/Ca=1.5) and room T.

FIG. 66—Concentration of the elements in kinetic samples at Na₂CO₃=0.807 g/250 ml (Na₂CO₃/Ca=2) and room T.

FIG. 67—Ca removal (%) and Li loss (%) in samples at Na₂CO₃=0.807 g/250 ml (Na₂CO₃/Ca=2) and room T.

FIG. 68—Ca removal (%) in presence of different reagents at room T.

FIG. 69—Concentration of elements in kinetic samples at pH=7 and Ba/SO₄=1 at room temperature.

FIG. 70—Concentration of elements in kinetic samples at pH=9 and Ba/SO₄=1 at room temperature.

FIG. 71—Concentration of elements in kinetic samples at pH=10 and Ba/SO₄=1 at room temperature.

FIG. 72—Concentration of elements in kinetic samples at pH=11 and Ba/SO₄=1 at room temperature.

FIG. 73—Concentration of elements in kinetic samples at pH=12 and Ba/SO₄=1 at room temperature.

FIG. 74—Effect of time and pH on sulfate removal at Ba/SO₄=1.

FIG. 75—Concentration of elements in kinetic samples at pH=9 and Ba/SO₄=0.9 at room temperature

FIG. 76—Concentration of elements in kinetic samples at pH=9 and Ba/SO₄=0.95 at room temperature.

FIG. 77—Concentration of elements in kinetic samples at pH=9 and Ba/SO₄=0.98 at room temperature.

FIG. 78—Concentration of elements in kinetic samples at pH=9 and Ba/SO₄=1.02 at room temperature.

FIG. 79—Concentration of elements in kinetic samples at pH=9 and Ba/SO₄=1.05 at room temperature.

FIG. 80—Concentration of elements in kinetic samples at pH=9 and Ba/SO₄=1.1 at room temperature.

FIG. 81—Effect of time and Ba/SO₄ ratio on sulfate removal at pH=9 and room T.

FIG. 82—Effect of time and Ba/SO₄ ratio on dissolved Ba in the solution at pH=9 and room T.

FIG. 83—Concentration of elements in kinetic samples at pH=9 and Ba/SO₄=1.05 at T=45° C.

FIG. 84—Concentration of elements in kinetic samples at pH=9 and Ba/SO₄=1.05 at T=65° C.

FIG. 85—Effect of time and T on sulfate removal at pH=9 and Ba/SO₄=1.05.

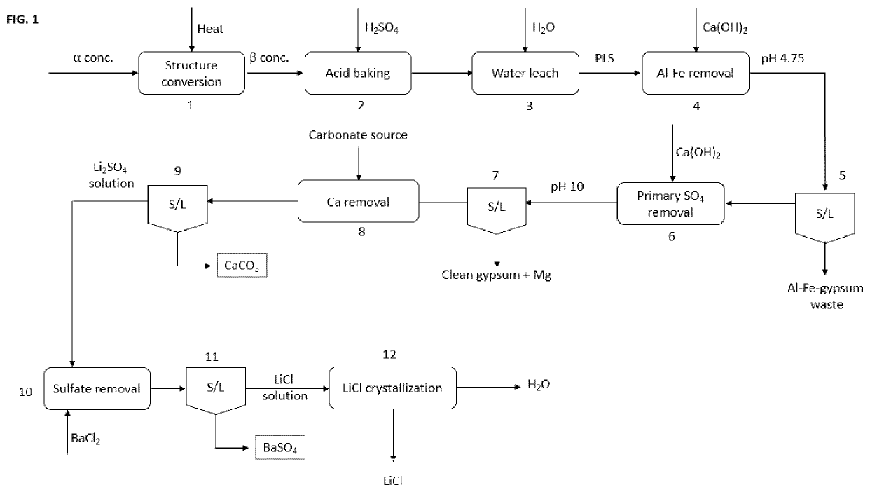

### DETAILED DESCRIPTION OF ILLUSTRATIVE EMBODIMENTS

### 1. Glossary/Definitions

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this specification and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

All methods or processes described herein can be performed in any suitable order unless otherwise indicated herein or otherwise clearly contradicted by context. Further, in embodiments, various steps may be repeated, for example to increase recovery and/or purification.

The use of any and all examples, or exemplary language (e.g., “such as”) provided herein, is intended merely to better illuminate the disclosure and does not pose a limitation on the scope of the disclosure unless otherwise claimed.

No language in the specification should be construed as indicating any non-claimed element as essential to the practice of the disclosure.

Unless otherwise defined, all technical and scientific terms used herein have the same meaning as commonly understood by the person of ordinary skill in the art (“POSITA”) to which this disclosure belongs.

In an aspect, the present disclosure relates to a process for recovering lithium chloride from an initial aqueous solution comprising lithium sulfate (Li₂SO₄), the process comprising: increasing the pH of the initial Li₂SO₄-comprising aqueous solution to reduce the level of species of one or more metals other than lithium and to remove sulfate; treating the solution after the reducing of the one or more metals other than lithium and the removal of sulfate with a material to remove calcium and to produce a solution substantially comprising Li₂SO₄; treating the solution substantially comprising Li₂SO₄ with barium chloride (BaCl₂) to form a precipitate comprising barium sulfate (BaSO₄) and a solution substantially comprising lithium chloride; and recovering the lithium chloride (LiCl) from the solution following BaSO₄ precipitation; wherein the aqueous solution comprising lithium sulfate (Li₂SO₄) is derived from a natural source or mineral deposit comprising a lithium species or from a synthetic or non-natural source comprising a lithium species.

Precipitation is understood in the chemical field to relate to the process by which one state is ejected or formed from another state, such as the creation of a solid from a solution, e.g., via a reaction that creates an insoluble product. The resulting precipitate or solid may remain in solution, may settle by gravity, or may be separated from the solution by other means, such as by sedimentation/centrifugation or filtration. The resulting liquid or solution remaining after sedimentation/centrifugation is often referred to as a supernate or supernatant; the resulting liquid or solution remaining after filtration is often referred to as a filtrate. In embodiments described herein, such resulting liquid or solution remaining after precipitation may be subjected to further treatments in a stepwise recovery or purification process. Similarly, in embodiments the precipitates may be treated to generate compounds for various uses, such as the recycling steps described herein. In embodiments, the precipitate may be subjected to one or more washes (e.g., with water), and the wash liquid may also be subjected to further treatments in a stepwise recovery or purification process (e.g., in combination with the resulting liquid or solution remaining after precipitation).

In an embodiment of the present disclosure, the lithium species may be recovered in the form of lithium chloride (LiCl) or a hydrate thereof, such as LiCl·H₂O.

### 2. Preparation of Li₂SO₄-Comprising Aqueous Solution

In an embodiment of the present disclosure, the process further comprises preparing the Li₂SO₄-comprising aqueous solution via treatment of a metal-comprising material with sulfuric acid (H₂SO₄) (e.g., via sulfuric acid leaching). In embodiments, the metal-comprising material comprises metal species other than lithium species, and recovery of the lithium species from such a material comprises obtaining a preparation enriched in lithium species and having reduced amounts of metal species other than lithium species, relative to the starting mixture. In embodiments, such metal species other than lithium comprise one or more Group I metals (other than lithium), Group Il metals, transition metals and/or post-transition metals. In embodiments, such metals other than lithium comprise one or more of calcium, sodium, magnesium, potassium, aluminum and iron.

In embodiments of the present disclosure, the Li₂SO₄-comprising aqueous solution has a pH of about 4.0 or less, in a further embodiment of about 3.5 or less, in a further embodiment of about 3.0 or less, in further embodiments of about 2.9 or less, 2.8 or less, 2.7 or less, 2.6 or less, or 2.5 or less. In further embodiments the Li₂SO₄-comprising aqueous solution has a pH of about 2.0 to about 3.0, about 2.1 to about 2.9, about 2.2 to about 2.8, about 2.3 to about 2.7, about 2.4 to about 2.6, or about 2.5.

### 3. Removal of Metal Species Other than Lithium Species

In embodiments of the present disclosure, the reduction of the amount/removal of metal species other than lithium species (e.g., Al, Fe, Mg, etc.) present in the Li₂SO₄-comprising aqueous solution may be accomplished by increasing the pH of the Li₂SO₄-comprising aqueous solution. In embodiments of the present disclosure, the reduction of the amount/removal of metal species other than lithium species present in the Li₂SO₄-comprising aqueous solution may be accomplished in a single step (e.g., a single pH increase) or in multiple steps (e.g., multiple pH increases). In embodiments of the present disclosure, the pH is increased by treatment with an alkaline material (e.g., lime, for example as a lime slurry or solid lime powder). In embodiments of the present disclosure, the pH is increased by treatment with one or more calcium salts, either in a single step or in multiple steps. In embodiments, the pH of the Li₂SO₄-comprising aqueous solution is adjusted to be about 3.0 or higher, in a further embodiment to be about 7.0 or higher, in a further embodiment about 3.0 to about 12.0, in a further embodiment about 3.0 to about 7.0, in a further embodiment about 9.0 to about 12.0, in a further embodiment about 3.0 to about 6.0, in a further embodiment about 3.5 to about 5.5, in a further embodiment about 4.0 to about 5.5, in a further embodiment about 4.5 to about 5.0, in a further embodiment about 4.6 to about 4.8 in further embodiments, about 4.5, about 4.75 or about 5.0.

In embodiments of the present disclosure, the metal species other than lithium, if in reduced form, may be treated with oxygen or other oxidants to be oxidized to more oxidized forms, prior to removal via pH adjustment.

In embodiments of the present disclosure, the reduction of the amount/removal of metal species other than lithium species may be performed at ambient temperature (e.g., about 22-25° C.) or higher, in a further embodiment at about 20° C. to about 30° C., in a further embodiment at about 25° C. to about 100° C., in a further embodiment at about 30° C. or higher, in a further embodiment at about 30° C. to about 100° C., in a further embodiment at about 35° C. or higher, in a further embodiment at about 35° C. to about 100° C., in a further embodiment about 40° C. or higher, in a further embodiment about 40° C. to about 100° C., in a further embodiment at about 45° C. or higher, in a further embodiment at about 45° C. to about 100° C., in a further embodiment at about 50° C. or higher, in a further embodiment at about 50° C. to about 100° C., in a further embodiment about 55° C. or higher, in a further embodiment about 55° C. to about 100° C., in a further embodiment at about 60° C. or higher, in a further embodiment at about 60° C. to about 100° C., in a further embodiment at about 65° C. or higher, in a further embodiment at about 65° C. to about 100° C., in a further embodiment about 70° C. or higher, in a further embodiment about 70° C. to about 100° C., in a further embodiment at about 75° C. or higher, in a further embodiment at about 75° C. to about 100° C., in a further embodiment at about 80° C. or higher, in a further embodiment at about 80° C. to about 100° C., in a further embodiment about 85° C. or higher, in a further embodiment about 85° C. to about 100° C., in a further embodiment at about 90° C. or higher, in a further embodiment at about 90° C. to about 100° C., in a further embodiment at about 95° C. or higher, in a further embodiment at about 95° C. to about 100° C., in a further embodiment at about 40° C. to about 50° C., in a further embodiment at about 60° C. to about 70° C., in a further embodiment at about 80° C. to about 90° C.

In embodiments of the present disclosure, the reduction of the amount/removal of metal species other than lithium species results in a removal of at least about 80%, at least about 85%, at least about 90%, at least about 91%, at least about 92%, at least about 93%, at least about 94%, at least about 95%, at least about 96%, at least about 97%, at least about 98%, at least about 99%, at least 99.5% of metal species other than lithium species.

In embodiments of the present disclosure, the step of reduction of the amount/removal of metal species other than lithium species results in less than about 10%, less than about 9%, less than about 8%, less than about 7%, less than about 6%, less than about 5%, less than about 4%, less than about 3%, less than about 2%, less than about 1%, or less than about 0.5% of lithium species being removed.

### 4. Further Removal of Metal Species Other than Lithium Species

In embodiments of the present disclosure, a further step for the reduction of the amount/removal of metal species other than lithium species may be performed, to for example remove other metals other than lithium species, for example via treatment with alkaline material (e.g., lime, for example as a lime slurry or solid lime powder) to increase the pH of the solution, for example to be about 7.0 or higher, in a further embodiment about 7.5 or higher, in a further embodiment about 8.0 or higher, in a further embodiment about 8.5 or higher, in a further embodiment about 9 or higher, in a further embodiment, about 9.5 to about 12.5, in a further embodiment about 9.0 to about 12.0, in a further embodiment, about 9.2 to about 12.0, in a further embodiment, about 9.0 to about 11.0, in a further embodiment, about 9.2 to about 10.8, in a further embodiment, about 9.4 to about 10.6, in a further embodiment, about 9.5 to about 10.5, in a further embodiment, about 9.6 to about 10.4, in a further embodiment, about 9.8 to about 10.2, in further embodiments about 9.0, about 9.5, about 10.0, about 10.5, about 11.0, about 11.5 or about 12.0.

In embodiments of the present disclosure, the further reduction of the amount/removal of metal species other than lithium species may be performed at ambient temperature (e.g., about 22-25° C.) or higher, in a further embodiment at about 20° C. to about 30° C., in a further embodiment at about 25° C. to about 100° C., in a further embodiment at about 30° C. or higher, in a further embodiment at about 30° C. to about 100° C., in a further embodiment at about 35° C. or higher, in a further embodiment at about 35° C. to about 100° C., in a further embodiment about 40° C. or higher, in a further embodiment about 40° C. to about 100° C., in a further embodiment at about 45° C. or higher, in a further embodiment at about 45° C. to about 100° C., in a further embodiment at about 50° C. or higher, in a further embodiment at about 50° C. to about 100° C., in a further embodiment about 55° C. or higher, in a further embodiment about 55° C. to about 100° C., in a further embodiment at about 60° C. or higher, in a further embodiment at about 60° C. to about 100° C., in a further embodiment at about 65° C. or higher, in a further embodiment at about 65° C. to about 100° C., in a further embodiment about 70° C. or higher, in a further embodiment about 70° C. to about 100° C., in a further embodiment at about 75° C. or higher, in a further embodiment at about 75° C. to about 100° C., in a further embodiment at about 80° C. or higher, in a further embodiment at about 80° C. to about 100° C., in a further embodiment about 85° C. or higher, in a further embodiment about 85° C. to about 100° C., in a further embodiment at about 90° C. or higher, in a further embodiment at about 90° C. to about 100° C., in a further embodiment at about 95° C. or higher, in a further embodiment at about 95° C. to about 100° C., in a further embodiment at about 40° C. to about 50° C., in a further embodiment at about 60° C. to about 70° C., in a further embodiment at about 62° C. to about 68° C., in a further embodiment at about 63° C. to about 67° C., in a further embodiment at about 80° C. to about 90° C.

In embodiments of the present disclosure, different sources of such a metal-comprising mixture may be used in the processes described herein. For example, natural sources or mineral deposits may be used, such as an ore, clay or brine comprising lithium species. In embodiments, such ores or clays comprise for example minerals such as lepidolite, hectorite, jaderite, spodumene, petalite and/or amblygonite. Brines include for example continental brines, geothermal brines and oilfield brines.

In an embodiment of the present disclosure, the natural source or mineral deposit is not a sulfide ore body.

In a further embodiment of the present disclosure, synthetic, non-natural, processed or man-made sources may be used as a starting material for the processes described herein, such as materials produced during recycling of lithium-ion batteries, e.g., from the electrode materials thereof (which in embodiments comprise lithium species such as lithium cobalt oxide (LiCoO₂), lithium manganese oxide (LiMn₂O₄), lithium iron phosphate (LiFePO₄), lithium nickel manganese Cobalt (NMC; Li(NiMnCo)O₂).

In embodiments of the present disclosure, such natural or synthetic/non-natural sources may be treated by hydrometallurgy, pyrometallurgy and/or electrometallurgy processes. In embodiments, such natural or synthetic/non-natural sources may be treated by processes such as calcination, roasting, alkali or acid treatment, and leaching (with water to generate an aqueous solution comprising metal salts).

In an embodiment of the present disclosure, the starting mixture (metal-comprising mixture) is not obtained by electrolysis.

In an embodiment of the present disclosure, the starting mixture (metal-comprising mixture) comprises lithium species in the form of lithium oxide (Li₂O).

In embodiments of the present disclosure, the precipitation of barium sulfate may be performed using barium chloride (BaCl₂) or hydrates thereof, such as BaCl₂·2H₂O.

### 5. Primary Sulfate Removal

In embodiments of the present disclosure, a primary sulfate removal step (e.g., in addition to and prior to the sulfate removal using BaCl₂) is implemented via precipitation with a salt other than barium chloride, such as one or more calcium salts. In an embodiment, the process described herein further comprises treating the Li₂SO₄-comprising aqueous solution with one or more calcium salts to form a precipitate comprising calcium sulfate (CaSO₄). This step is carried out prior to precipitation with barium chloride and prior to precipitation with a carbonate source (e.g., the solution remaining after CaSO₄ and carbonate precipitation is treated with barium chloride to form the precipitate comprising BaSO₄).

In embodiments of the present disclosure, such a primary step of sulfate removal, prior to treatment with barium chloride, is performed via treatment with a salt other than barium chloride, such as one or more calcium salts, such as in the form of an alkaline material (e.g., lime, for example as a lime slurry or solid lime powder) to increase the pH of the solution, for example to be about 3.0 or higher, or to be about 7.0 or higher, in a further embodiment 4.5 or higher, in a further embodiment 5.0 or higher, in a further embodiment 5.5 or higher, in a further embodiment 6.0 or higher, in a further embodiment 6.5 or higher, in a further embodiment 7.0 or higher, in a further embodiment about 7.5 or higher, in a further embodiment about 8.0 or higher, in a further embodiment about 8.5 or higher, in a further embodiment about 9 or higher, in a further embodiment, in a further embodiment about 3.0 to about 12.0, in a further embodiment about 3.0 to about 7.0, in a further embodiment about 9.5 to about 12.0, in a further embodiment about 9.0 to about 12.0, in a further embodiment, about 9.2 to about 12.0, in a further embodiment, about 9.0 to about 10.0, in a further embodiment, about 9.0 to about 11.0, in a further embodiment, about 9.5 to about 10.5, in further embodiments about 9.0, about 9.5, about 10.0, about 10.5, about 11.0, about 11.5 or about 12.0. In embodiments of the present disclosure, the primary step of sulfate removal may be accomplished in a single step (e.g., a single pH increase) or in multiple steps (e.g., multiple pH increases). In an embodiment of the present disclosure, such a primary step of sulfate removal also results in the further reduction of the amount/removal of metal species other than lithium species. In embodiments of the present disclosure, the steps of further removal of metal species other than lithium species and primary sulfate removal may be combined into one step.

In embodiments of the present disclosure, the steps of removal of metal species other than lithium species and primary sulfate removal may be combined into one step, via direct treatment of the Li₂SO₄-comprising aqueous solution with one or more calcium salts in the form of an alkaline material (e.g., lime, for example as a lime slurry or solid lime powder) to increase the pH of the solution as noted above, thus resulting in both removal of metal species other than lithium species and primary sulfate precipitation in a single step.

Following treatment with one or more calcium salts, gypsum is produced as a by-product. In embodiments of the present disclosure, the gypsum may be recycled for other purposes. In such cases, it is preferred to perform the removal of the metal species other than lithium species and primary sulfate removal in separate steps, such that the gypsum produced is of greater purity and has fewer metal contaminants. For greater clarity, in such cases, the pH is increased by treatment with one or more calcium salts in the form of an alkaline material (e.g., lime, for example as a lime slurry or solid lime powder), in multiple steps. For example, a first removal step may be carried out at a pH of about 4.0 to about 5.5 to produce a first gypsum-containing mixture which also contains metal species other than lithium species (e.g., Al, Fe), followed by a second removal step at a pH of about 9 to 11 to produce a second gypsum-containing mixture, wherein the gypsum in the second gypsum-containing mixture is of greater purity and has fewer metal contaminants relative to that of the first gypsum-containing mixture.

In embodiments of the present disclosure, the Li₂SO₄-comprising aqueous solution is treated with the one or more calcium salts at a molar ratio of calcium to sulfate of about 80% to about 120%, about 90% to about 120%, about 100% to about 120%, about 90% to about 110%, about 80%, about 90%, about 100%, about 110% or about 120%.

### 6. Calcium Removal

In embodiments of the present disclosure, a calcium removal step (e.g., in addition to and prior to the sulfate removal using BaCl₂) is implemented via precipitation with a carbonate source in the form of a carbonate salt or CO₂ gas. In an embodiment, the process described herein further comprises treating the Li₂SO₄-comprising aqueous solution, following primary sulfate removal, with one or more carbonate salts to form a precipitate comprising one or more metal carbonates. In particular embodiments of the present disclosure, the carbonate salt is at least one of sodium carbonate (Na₂CO₃) or lithium carbonate (Li₂CO₃) and the one or more metal carbonates are one or more of calcium carbonate and magnesium carbonate. This step is carried out prior to precipitation with barium chloride and following primary sulfate removal (e.g., the solution remaining after CaSO₄ precipitation is treated with a carbonate source).

In embodiments of the present disclosure, the calcium removal step may be performed at a pH of about 7.0 or higher, in a further embodiment about 7.5 or higher, in a further embodiment about 8.0 or higher, in a further embodiment about 8.5 or higher, in a further embodiment about 9 or higher, in a further embodiment, about 9.5 to about 12.5, in a further embodiment, about 9.5 to about 12.5, in a further embodiment about 8.0 to about 10.0, in a further embodiment, about 8.2 to about 9.8, in a further embodiment, about 8.4 to about 9.6, in a further embodiment, about 8.5 to about 9.5, in a further embodiment, about 8.6 to about 9.4, in a further embodiment, about 8.7 to about 9.3, in a further embodiment, about 9.2 to about 12.0, in a further embodiment, about 9.0 to about 11.0, in a further embodiment, about 9.2 to about 10.8, in a further embodiment, about 9.4 to about 10.6, in a further embodiment, about 9.5 to about 10.5, in a further embodiment, about 9.6 to about 10.4, in a further embodiment, about 9.8 to about 10.2, in further embodiments about 9.0, about 9.5, about 10.0, about 10.5, about 11.0, about 11.5 or about 12.0.

In embodiments of the present disclosure, the further reduction of the amount/removal of metal species other than lithium species may be performed at ambient temperature (e.g., about 22 to about 25° C.) or higher, in a further embodiment at about 20° C. to about 25° C. in a further embodiment at about 20° C. to about 30° C., in a further embodiment at about 25° C. to about 100° C., in a further embodiment at about 30° C. or higher, in a further embodiment at about 30° C. to about 100° C., in a further embodiment at about 35° C. or higher, in a further embodiment at about 35° C. to about 100° C., in a further embodiment about 40° C. or higher, in a further embodiment about 40° C. to about 100° C., in a further embodiment at about 45° C. or higher, in a further embodiment at about 45° C. to about 100° C., in a further embodiment at about 50° C. or higher, in a further embodiment at about 50° C. to about 100° C., in a further embodiment about 55° C. or higher, in a further embodiment about 55° C. to about 100° C., in a further embodiment at about 60° C. or higher, in a further embodiment at about 60° C. to about 100° C., in a further embodiment at about 65° C. or higher, in a further embodiment at about 65° C. to about 100° C., in a further embodiment about 70° C. or higher, in a further embodiment about 70° C. to about 100° C., in a further embodiment at about 75° C. or higher, in a further embodiment at about 75° C. to about 100° C., in a further embodiment at about 80° C. or higher, in a further embodiment at about 80° C. to about 100° C., in a further embodiment about 85° C. or higher, in a further embodiment about 85° C. to about 100° C., in a further embodiment at about 90° C. or higher, in a further embodiment at about 90° C. to about 100° C., in a further embodiment at about 95° C. or higher, in a further embodiment at about 95° C. to about 100° C., in a further embodiment at about 40° C. to about 50° C., in a further embodiment at about 60° C. to about 70° C., in a further embodiment at about 62° C. to about 68° C., in a further embodiment at about 63° C. to about 67° C., in a further embodiment at about 80° C. to about 90° C.

In embodiments of the present disclosure, the treatment with the carbonate source is performed at a molar ratio of carbonate to calcium of about 80% to about 250% about 80% to about 120%, about 90% to about 120%, about 100% to about 120%, about 90% to about 110%, about 80%, about 90%, about 100%, about 110% or about 120%, of about 80% to about 2500%, about 150% to about 250%, about 175% to about 225%, about 180% to about 220%, about 190% to about 210%, about 195% to about 205%, or about 200%.

In embodiments of the present disclosure, the treatment with the carbonate source is performed at a molar ratio of carbonate to one or more metals (e.g. calcium and/or magnesium) of about 80% to about 120%, about 90% to about 120%, about 100% to about 120%, about 90% to about 110%, about 80%, about 90%, about 100%, about 110% or about 120%.

### 7. Secondary Sulfate Removal with Barium Chloride

In embodiments of the present disclosure, the Li₂SO₄-comprising aqueous solution, following removal of the metal species other than lithium species, primary sulfate removal and calcium removal, is treated with barium chloride at a pH of about 6.0 or higher, in a further embodiment about 7.0 or higher, in a further embodiment about 7.5 or higher, in a further embodiment about 8.0 or higher, in a further embodiment about 8.5 or higher, in a further embodiment about 9 or higher, in a further embodiment, about 8.0 to about 10.0, in a further embodiment, about 8.5 to about 9.5, in a further embodiment, about 8.6 to about 9.4, in a further embodiment, about 8.7 to about 9.3, in a further embodiment, about 8.8 to about 9.2, in a further embodiment, about 8.9 to about 9.1, in a further embodiment, about 9.5 to about 12.0, in a further embodiment about 9.0 to about 12.0, in a further embodiment, about 9.2 to about 12.0, in a further embodiment, about 9.0 to about 11.0, in a further embodiment, about 9.0 to about 10.0, in a further embodiment, about 9.5 to about 10.5, in further embodiments about 9.0, about 9.5, about 10.0, about 10.5, about 11.0, about 11.5 or about 12.0. In an embodiment of the present disclosure, BaSO₄ precipitation may be performed without adjusting the pH of the mixture prior to the addition of the barium chloride.

In embodiments, the barium chloride is added at a molar ratio of barium to sulfate at a ratio of about 0.1 to about 3.0, at a ratio of about 0.8 to about 1.5, at a ratio of about 0.9 to about 1.2, at a ratio of about 0.9 to about 1.1, at a ratio of about 0.95 to about 1.1, at a ratio of about 0.95 to about 1.05, at a ratio of about 0.98 to about 1.02, at a ratio of about 1.0 to about 1.2, at a ratio of about 1.0 to about 1.1, at a ratio of about 1.0 to about 1.05, in further embodiments at a ratio of about 0.9, 0.95, 0.98, 1.0, 1.02 1.05, 1.08 or 1.10.

In embodiments of the present disclosure, the Li₂SO₄-comprising aqueous solution is treated with barium chloride at a molar ratio of barium to sulfate of about 10% to about 300%, about 80% to about 150%, about 80% to about 120%, about 90% to about 120%, about 100% to about 120%, about 90% to about 110%, about 95% to about 110%, about 80%, about 90%, about 100%, about 110% or about 120%.

In embodiments of the present disclosure, the Li₂SO₄-comprising aqueous solution is treated with barium chloride at a temperature of about 1° C. to about 100° C., about 5° C. to about 75° C., about 5° C. to about 60° C., about 10° C. to about 60° C., about 15° C. to about 60° C., about 20° C. to about 60° C., about 20° C. to about 30° C., or at room temperature (e.g., about 25° C.).

In embodiments of the present disclosure, the concentration of lithium in the Li₂SO₄-comprising aqueous solution is about 1 to about 25 g/L, about 5 to about 25 g/L, about 5 to about 20 g/L, about 5 to about 15 g/L, about 8 to about 12 g/L about 5 g/L, about 6 g/L, about 7 g/L, about 8 g/L, about 9 g/L, about 10 g/L, about 11 g/L, about 12 g/L, about 13 g/L, about 14 g/L, or about 15 g/L.

In embodiments of the present disclosure, at least about 50%, 55%, 60%, 65%, 70%, 75%, 80%, 90%, 95% or 99% of the lithium species is recovered from the Li₂SO₄-comprising aqueous solution. In embodiments, about 50% to about 99%, about 55% to about 99%, about 60% to about 99%, about 65% to about 99%, about 70% to about 99%, about 75% to about 99%, about 80% to about 99%, or about 90% to about 99% of the lithium species is recovered from the Li₂SO₄-comprising aqueous solution.

In an embodiment, the present disclosure relates to a process for recovering lithium chloride from a material comprising a lithium species and species of one or more metals other than lithium, the process comprising:
treating the material with sulfuric acid (H₂SO₄) to provide an initial Li₂SO₄-comprising aqueous solution;
increasing the pH of the initial Li₂SO₄-comprising aqueous solution to reduce the level of species of one or more metals other than lithium and to remove sulfate;
treating the solution after the reducing of the one or more metals other than lithium and the removal of sulfate with a material to remove calcium and to produce a solution substantially comprising Li₂SO₄;
treating the solution substantially comprising Li₂SO₄ with barium chloride to form a precipitate comprising barium sulfate and a solution substantially comprising lithium chloride; and
recovering the lithium chloride from the solution remaining following the removal of the barium sulfate comprising precipitate in the form of lithium chloride or a hydrate thereof, via heat treatment and crystallization.

In embodiments, the processes described herein further comprise one or more steps to remove or reduce the level of non-lithium metal species present in the solutions or filtrates obtained during the process. In embodiments, such steps are carried out prior to BaSO₄ and after CaSO₄ precipitation. For greater clarity, such steps are carried out prior to BaSO₄ precipitation and recovery of the lithium species. In embodiments, such further treatment comprises treating the solution remaining after CaSO₄ precipitation with any source of carbonate, such as CO₂ gas, and/or a carbonate salt, to form a precipitate comprising one or more metal carbonates of the one or more metals other than lithium. In embodiments, the carbonate salt is sodium carbonate (Na₂CO₃) or lithium carbonate (Li₂CO₃), or a combination thereof. In embodiments the non-lithium metals include calcium and/or magnesium, in which case treatment with a source of carbonate (e.g., CO₂ gas and/or carbonate) salt shall generate calcium carbonate and/or magnesium carbonate.

In embodiments of the present disclosure, the process further comprises a step of recovering the lithium species from the solution, for example by crystallization. In embodiments, such a step comprises for example heat treatment to remove or boil off at least a part of the water in the solution. In a further embodiment, such a step may comprise for example subjecting the aqueous solution to reduced pressure (e.g., vacuum treatment). In embodiments, at least about 10% of the water is removed, in a further embodiment, at least about 15% of the water is removed, in a further embodiment, at least about 20% of the water is removed, in a further embodiment, at least about 25% of the water is removed, in a further embodiment, in a further embodiment, at least about 30% of the water is removed, in a further embodiment, at least about 35% of the water is removed, in a further embodiment, at least about 40% of the water is removed, in a further embodiment, at least about 45% of the water is removed, in a further embodiment, at least about 50% of the water is removed, in a further embodiment, at least about 55% of the water is removed, in a further embodiment, at least about 60% of the water is removed, in a further embodiment, at least about 65% of the water is removed, in a further embodiment, at least about 70% of the water is removed, in a further embodiment, at least about 75% of the water is removed, in a further embodiment, at least about 80% of the water is removed, in a further embodiment, at least about 85% of the water is removed, in a further embodiment, at least about 90% of the water is removed, or, in a further embodiment, at least about 95% of the water is removed.

In embodiments of the present disclosure, various products obtained in one or more steps of the process may be recycled back to a form for use in the process. For example, in embodiments, the BaSO₄ may be treated, e.g. by calcination, to form BaO and SO₃. In embodiments, the regenerated SO₃ may be subjected to water treatment to form H₂SO₄, which can then be used to prepare the Li₂SO₄-comprising aqueous solution, e.g., for treating the starting material described herein.

BaSO₄ is generated when barium chloride is added to the sulphate solution. The solid barium sulphate precipitate is separated from the lithium solution for example by filtration, centrifugation or by settling in a thickener.

The present disclosure is illustrated in further detail by the following non-limiting examples.

### Example 1—Al—Fe Removal from Li Pregnant Leach Solution (PLS)

This step comprised treating the PLS from an original pH of about 2 to about 3 to an optimum pH of 4.75 at room temperature (22° C.) using a 5% pulp density lime slurry to precipitate gypsum along with iron and aluminum. The expected reactions in this step are:

$$F {{e}_{2} ( S {O}_{4} )}_{3} + 3 C {a ( O H )}_{2} + 6 {H}_{2} O = 2 F {e ( O H )}_{3} + 3 C a S {O}_{4} \cdot 2 {H}_{2} O$$

$$F e S {O}_{4} + C {a ( O H )}_{2} + 2 {H}_{2} O = F {e ( O H )}_{2} + C a S {O}_{4} \cdot 2 {H}_{2} O$$

$$A {{l}_{2} ( S {O}_{4} )}_{3} + 3 C {a ( O H )}_{2} + 6 {H}_{2} O = 2 A {l ( O H )}_{3} + 3 C a S {O}_{4} \cdot 2 {H}_{2} O$$

$${H}_{2} S {O}_{4} + C {a ( O H )}_{2} = C a S {O}_{4} \cdot 2 {H}_{2} O$$

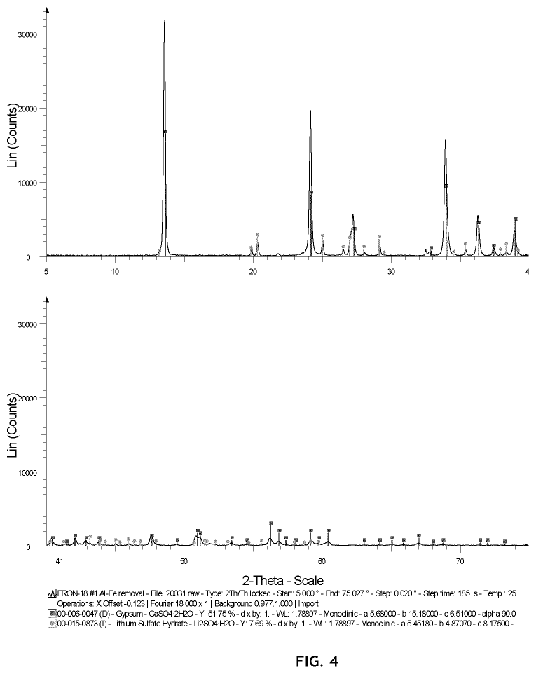

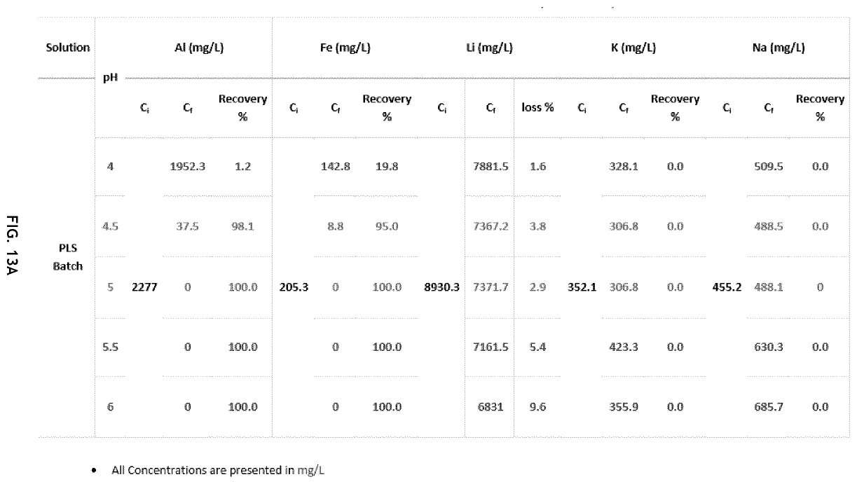

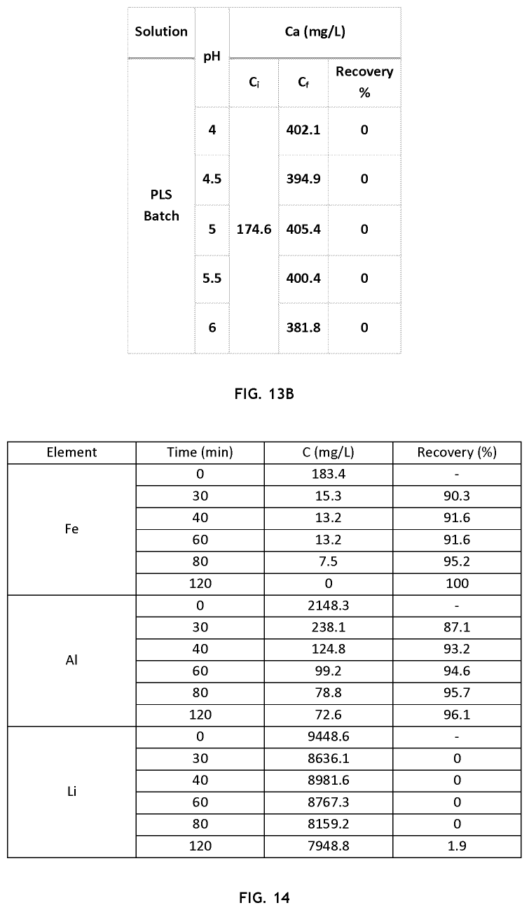

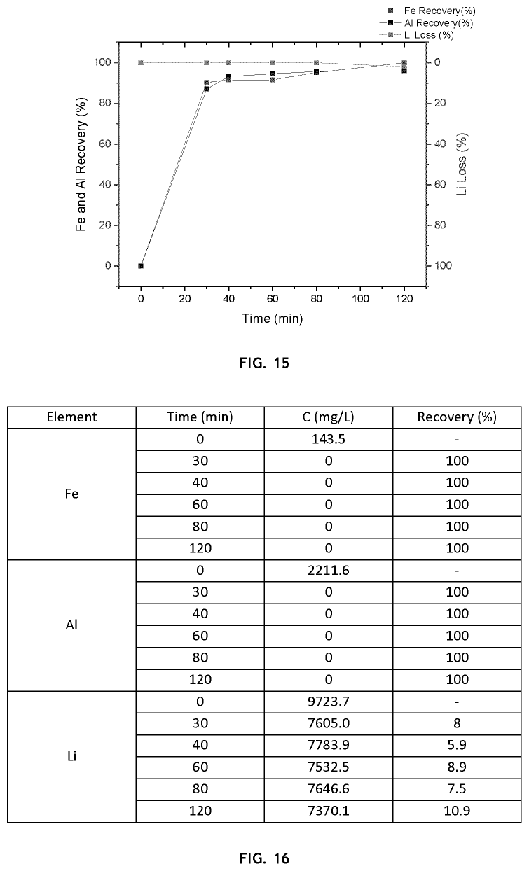

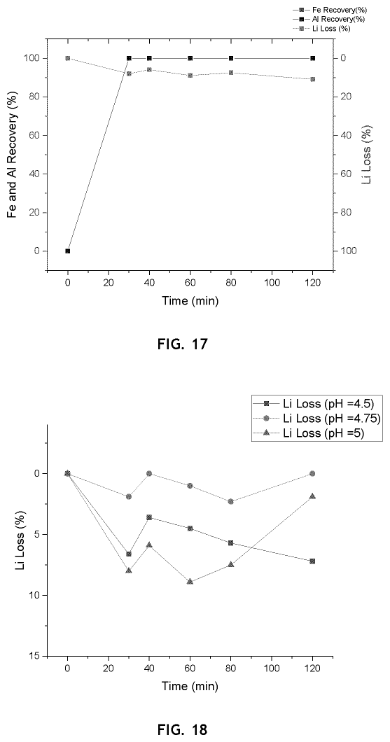

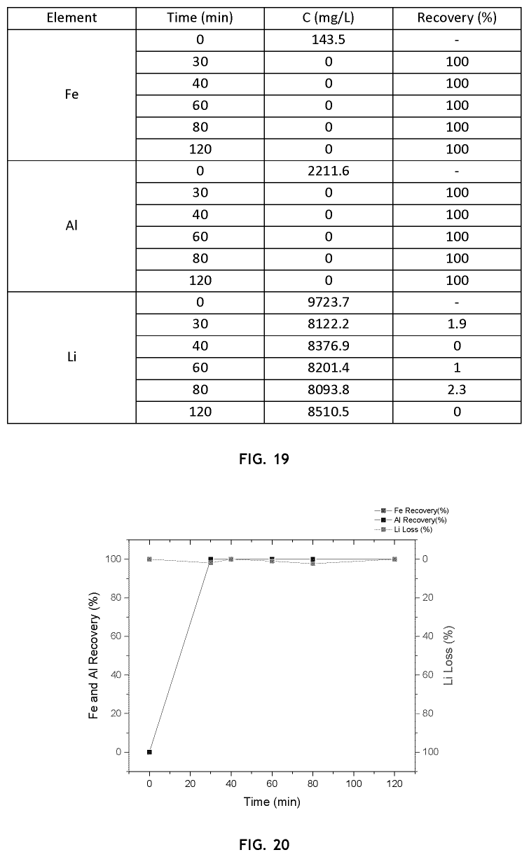

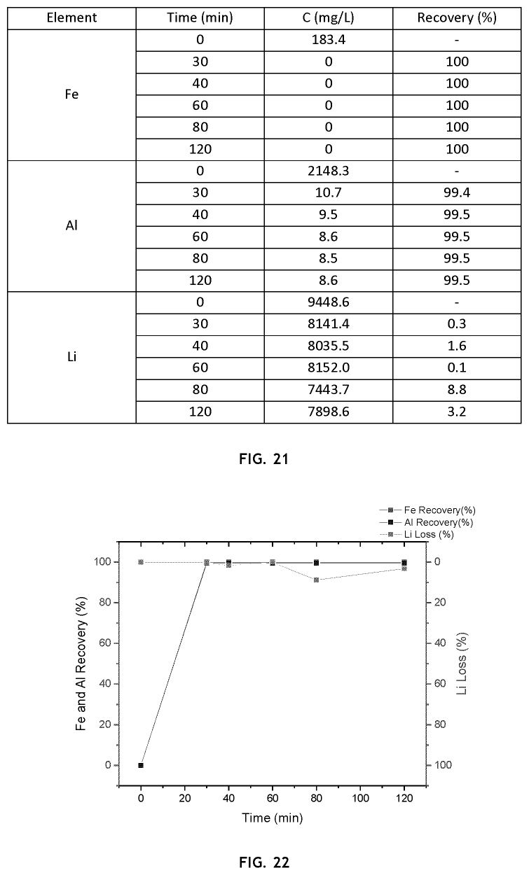

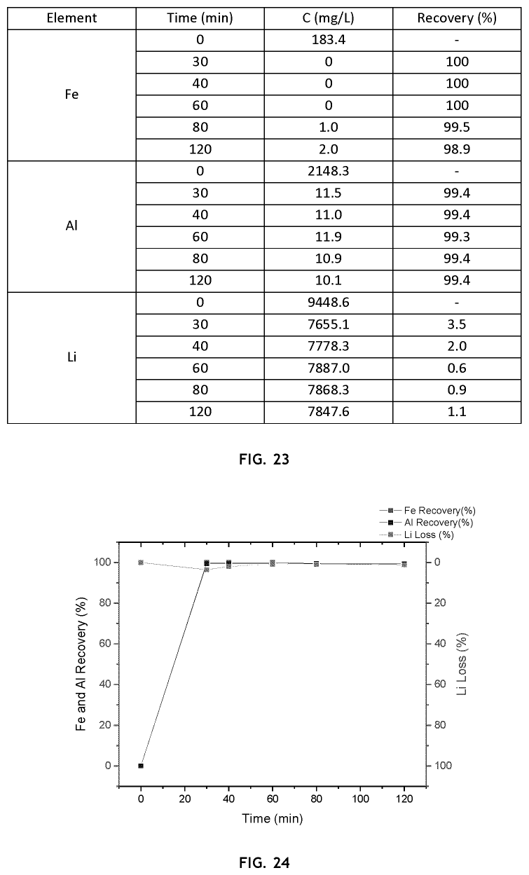

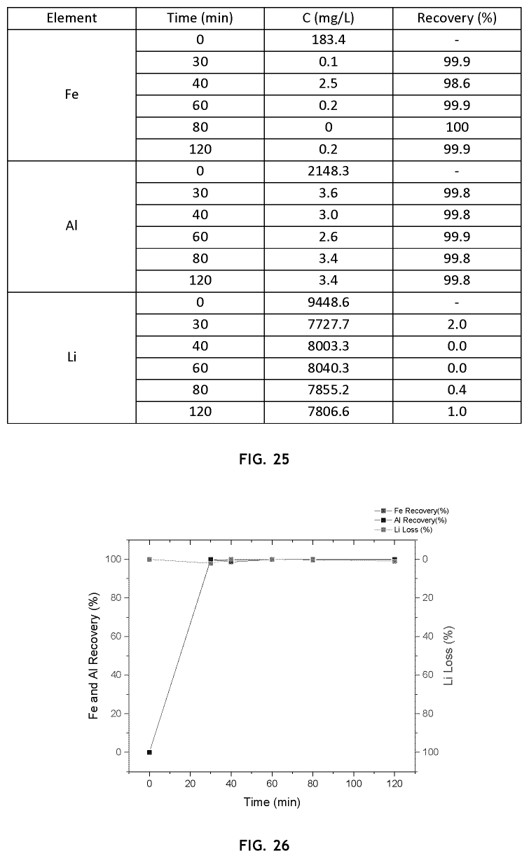

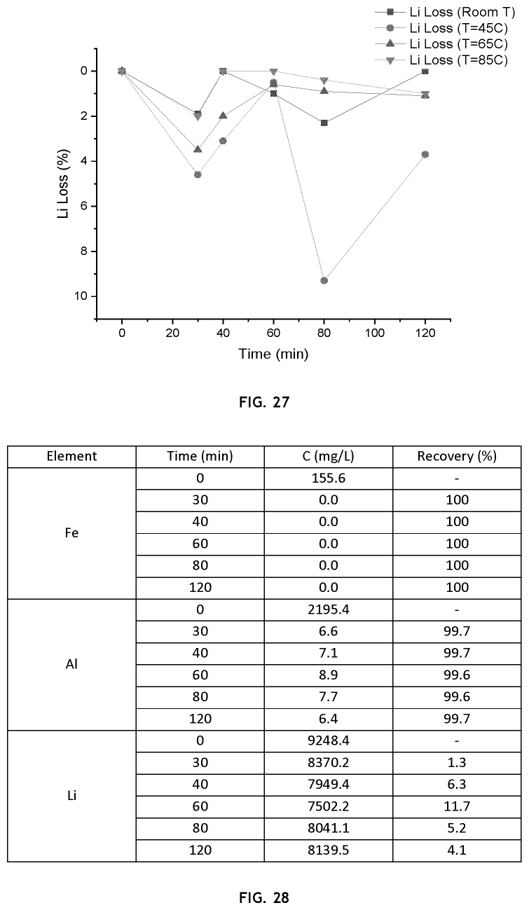

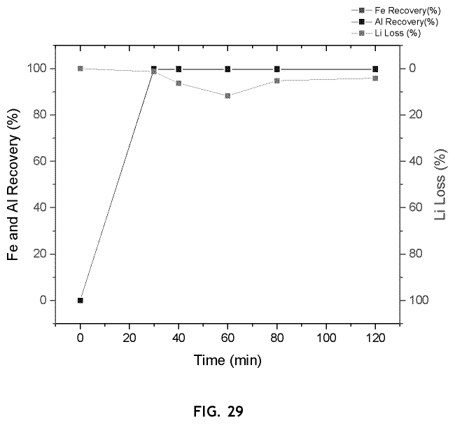

The observed results are indicative that a pH of about 4.75 provides for good performance, and there is no need for iron oxidation as it appears that all the iron in solution is ferric and can be easily precipitated. Test conditions and the composition of products are shown in Tables 1-1 and 1-2, and FIGS. 3 and 4. FIG. 4 presents the XRD of the final solid residue, confirming iron and aluminum hydroxides and gypsum. See also FIGS. 13-29.

TABLE 1-1
Al—Fe removal test conditions

| | Parameters | | | |
|---|---|---|---|---|
| | Terminal | Lime slurry | T | Kinetic |
| Test # | pH | PD | (° C.) | samples? |
| 1-1 | 4 | 5% | 25 | Yes |
| 1-2 | 4.5 | 5% | 25 | Yes |
| 1-3 | 5 | 5% | 25 | Yes |
| 1-4 | 5.5 | 5% | 25 | Yes |
| 1-5 | 6 | 5% | 25 | Yes |
| 1-6 | 4.75 | 5% | 45 | Yes |
| 1-7 | 4.75 | 5% | 65 | Yes |
| 1-8 | 4.75 | 5% | 85 | Yes |
| 1-9 | 4.75 | 1% | 25 | Yes |
| 1-10 | 4.75 | 10% | 25 | Yes |
| Optimum | 4.75 | 5% | 25 | Yes |

TABLE 1-2
Concentration of Fe, Al and Li in kinetic samples at pH = 4.75

| | Time | C | Recovery |
|---|---|---|---|
| Element | (min) | (mg/L) | (%) |
| Fe | 0 | 143.5 | — |
| | 30 | 0 | 100 |
| | 40 | 0 | 100 |
| | 60 | 0 | 100 |
| | 80 | 0 | 100 |
| | 120 | 0 | 100 |
| Al | 0 | 2211.6 | — |
| | 30 | 0 | 100 |
| | 40 | 0 | 100 |
| | 60 | 0 | 100 |
| | 80 | 0 | 100 |
| | 120 | 0 | 100 |
| Li | 0 | 9724 | — |
| | 30 | 8122 | 1.9 |
| | 40 | 8377 | 0 |
| | 60 | 8201 | 1 |
| | 80 | 8094 | 2.3 |
| | 120 | 8262 | 0 |

### Example 2—Mg and Other Base Metal Removal from Li Pregnant Leach Solution (PLS)

This step comprised treating the PLS with more lime (Mg removal step) to a pH of about 10 (lime saturation condition) at 65° C. using a 5% pulp density lime slurry to precipitate gypsum and Mg(OH)₂. The expected reactions in this step are:

$$M g S {O}_{4} + C {a ( O H )}_{2} + 2 {H}_{2} O = M {g ( O H )}_{2} + C a S {O}_{4} \cdot 2 {H}_{2} O ( major reaction )$$

$$M S {O}_{4} + C {a ( O H )}_{2} + 2 {H}_{2} O = {M ( O H )}_{2} + C a S {O}_{4} \cdot 2 {H}_{2} O ( major reaction ; M = N i , C o , M n , etc . )$$

$${H}_{2} S {O}_{4} + C {a ( O H )}_{2} = C a S {O}_{4} \cdot 2 {H}_{2} O ( minor reaction )$$

$$L {i}_{2} S {O}_{4} + C {a ( O H )}_{2} + 2 {H}_{2} O = C a S {O}_{4} \cdot 2 {H}_{2} O + 2 L i O H ( minor reaction )$$

$$F {{e}_{2} ( S {O}_{4} )}_{3} + 3 C {a ( O H )}_{2} + 6 {H}_{2} O = 2 F {e ( O H )}_{3} + 3 C a S {O}_{4} \cdot 2 {H}_{2} O ( if any present in the PLS )$$

$$F e S {O}_{4} + C {a ( O H )}_{2} + 2 {H}_{2} O = F {e ( O H )}_{2} + C a S {O}_{4} \cdot 2 {H}_{2} O ( if any present in the PLS )$$

$$A {{l}_{2} ( S {O}_{4} )}_{3} + 3 C {a ( O H )}_{2} + 6 {H}_{2} O = 2 A {l ( O H )}_{3} + 3 C a S {O}_{4} \cdot 2 {H}_{2} O ( if any present in the PLS )$$

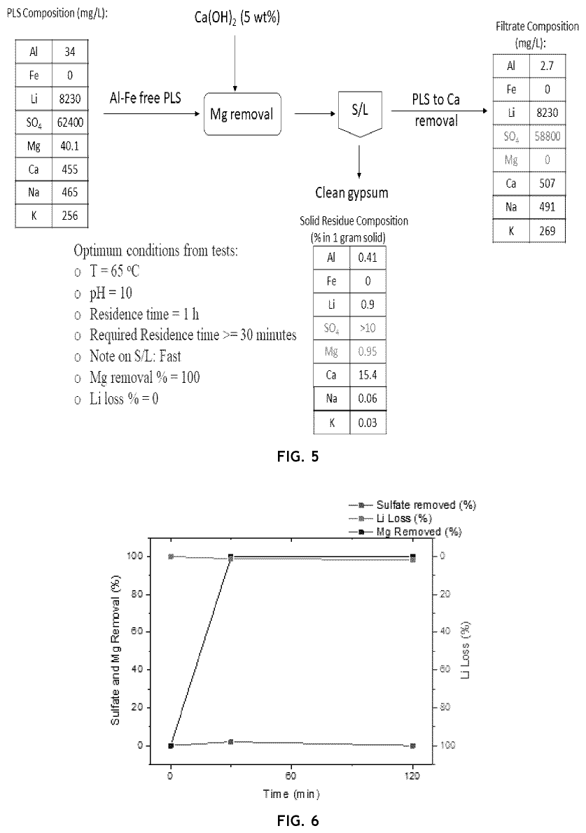

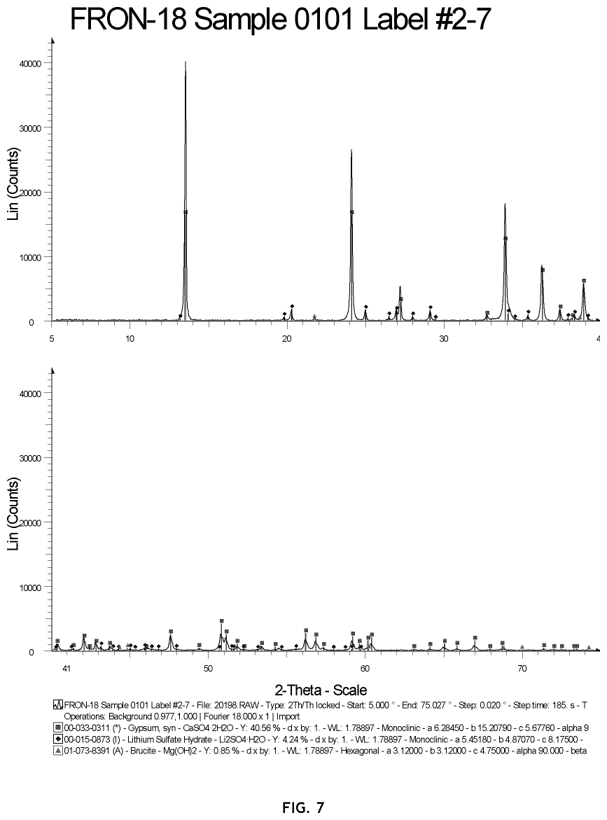

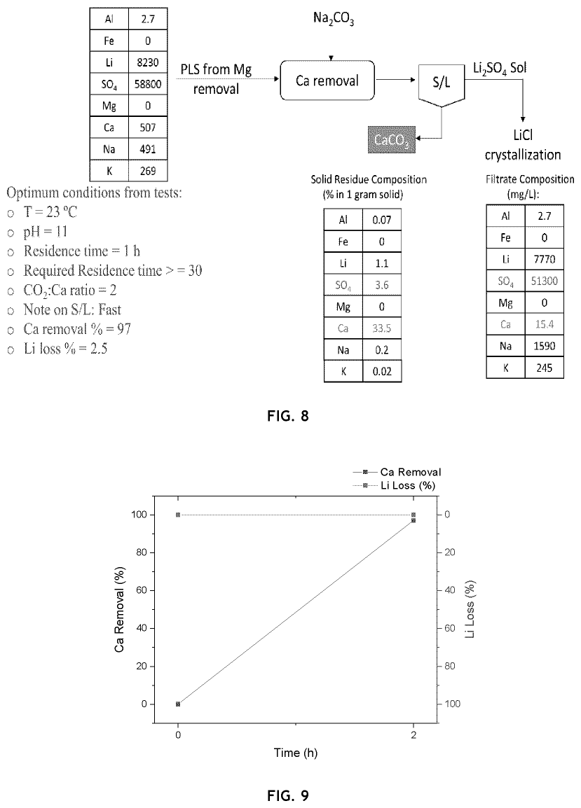

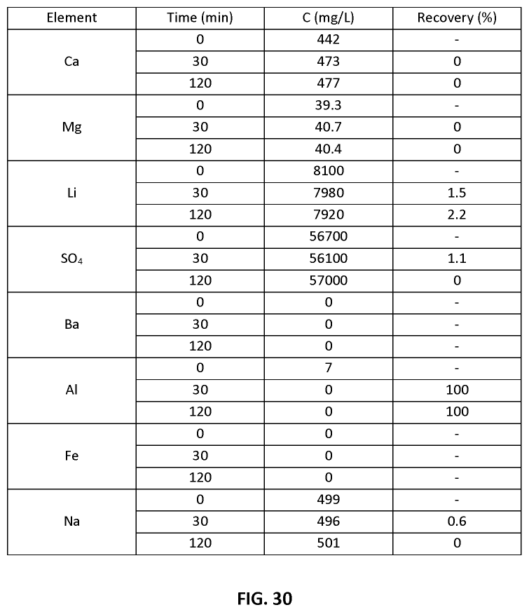

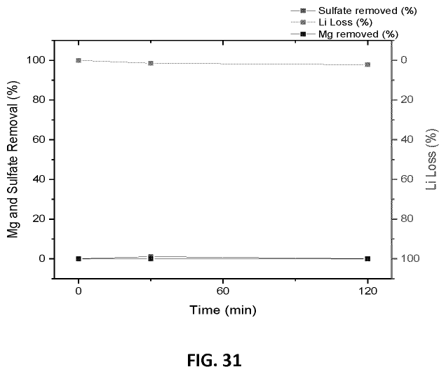

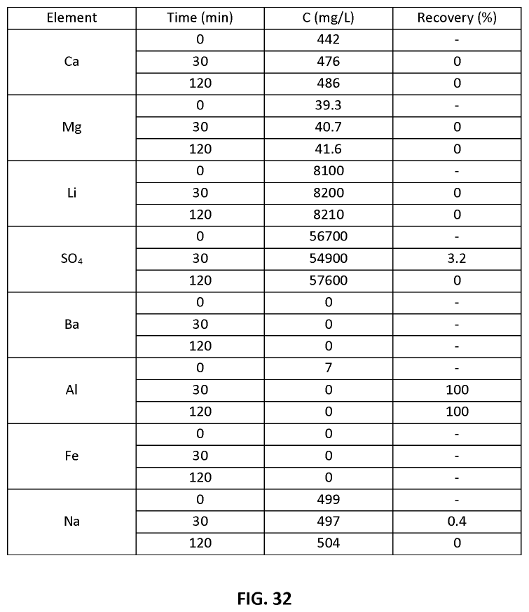

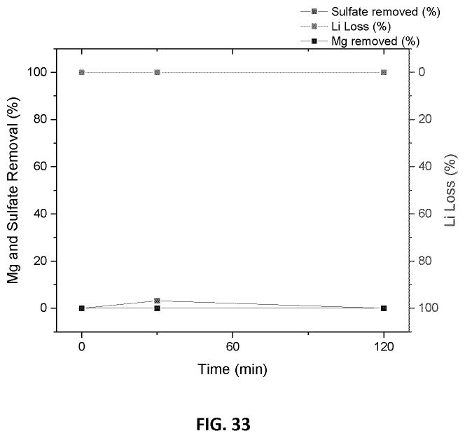

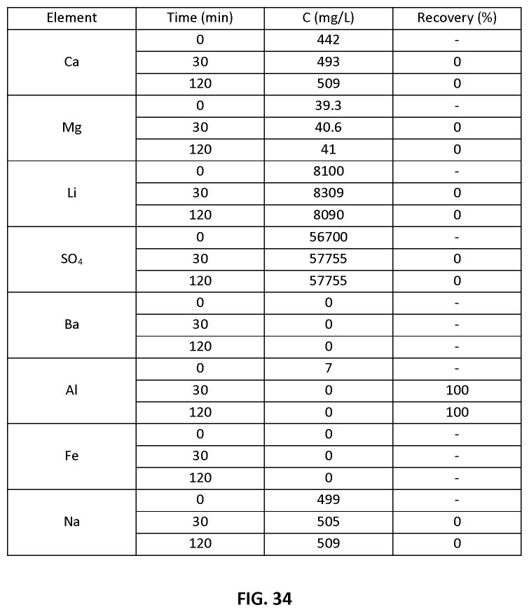

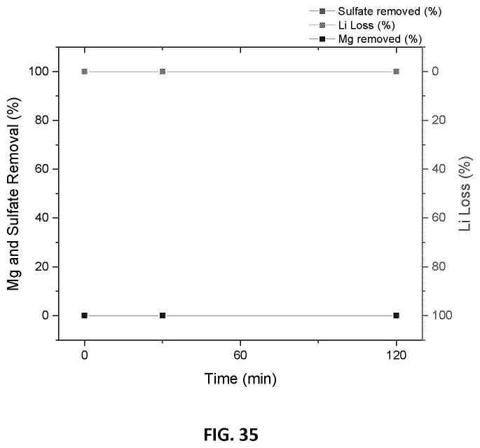

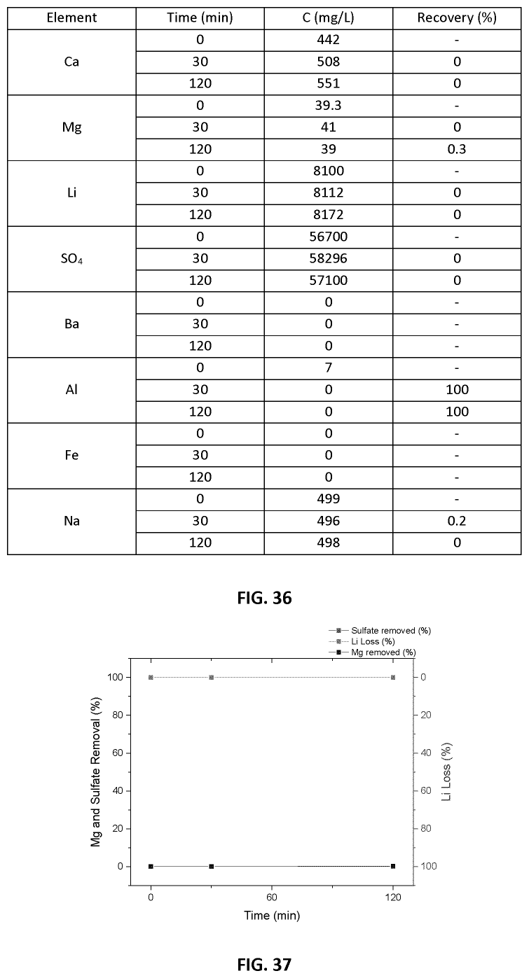

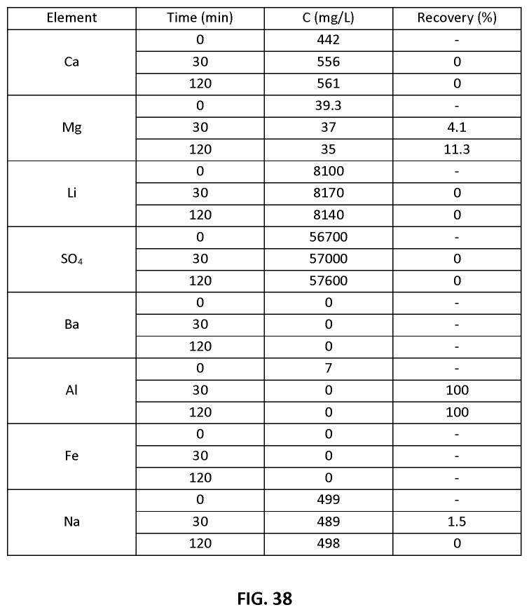

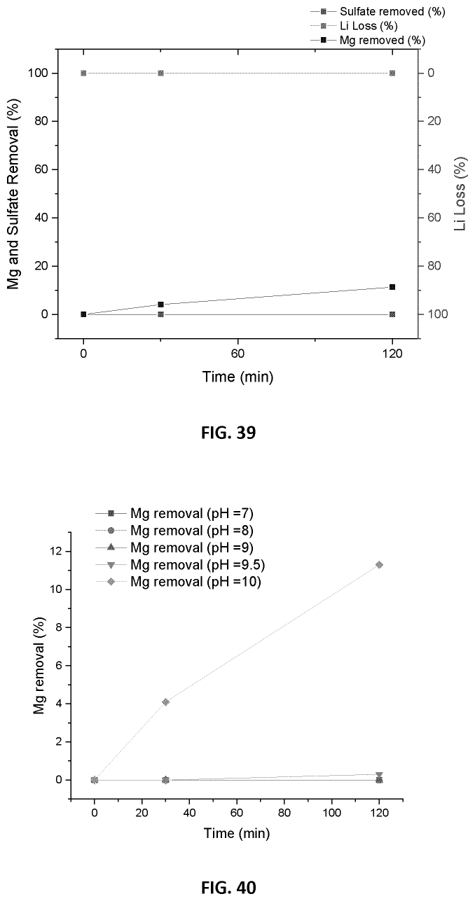

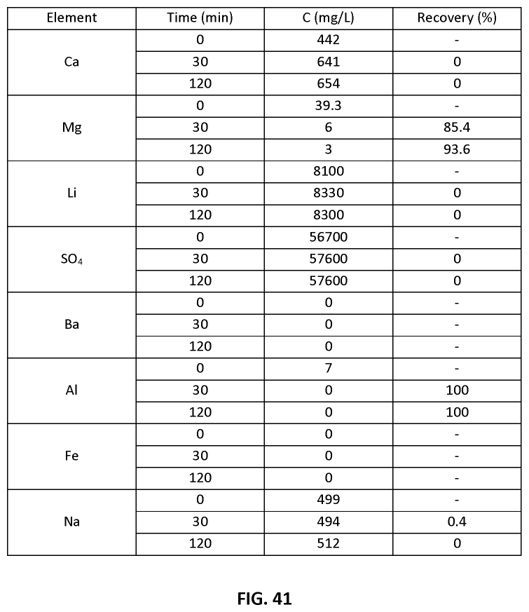

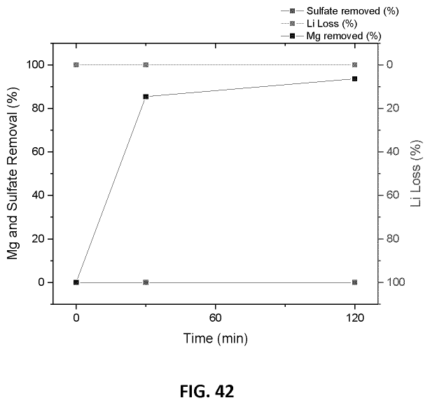

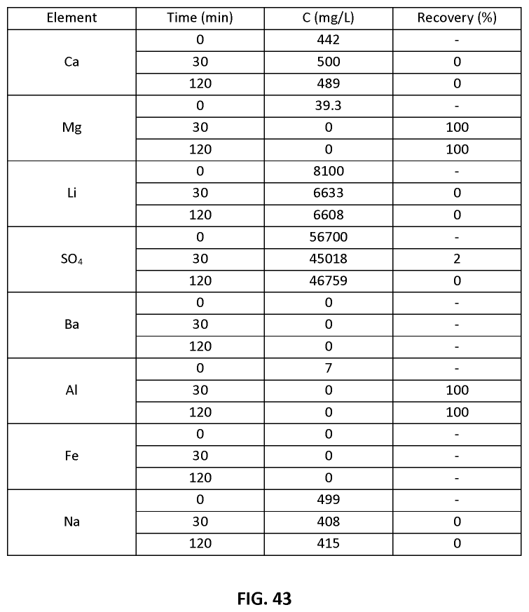

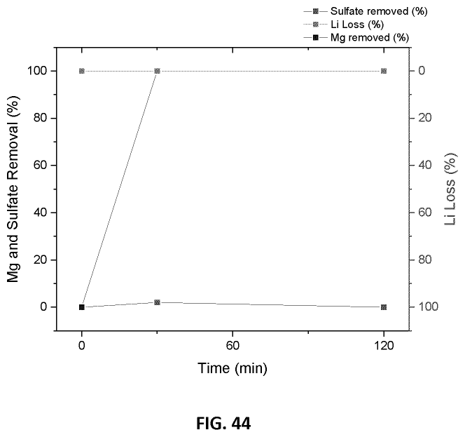

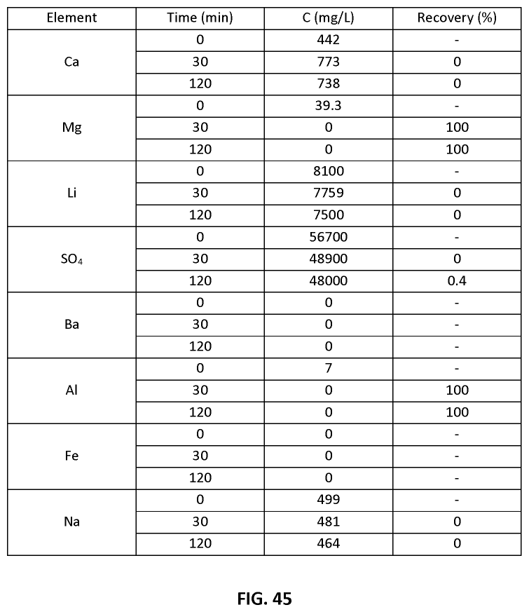

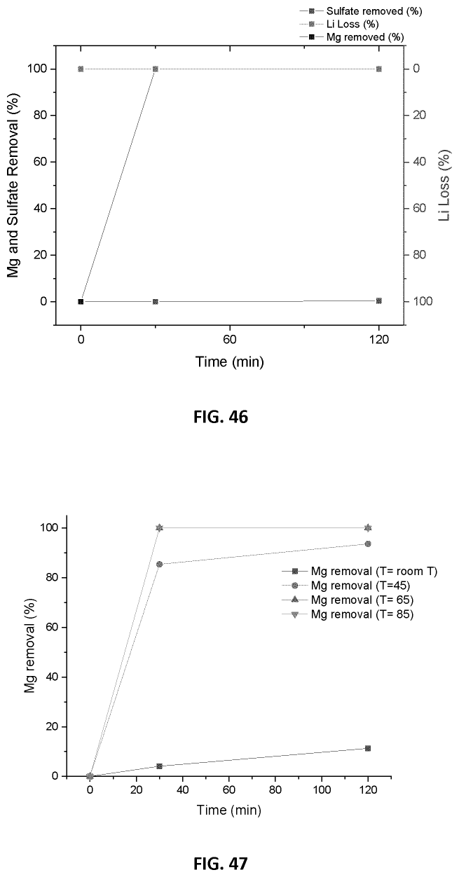

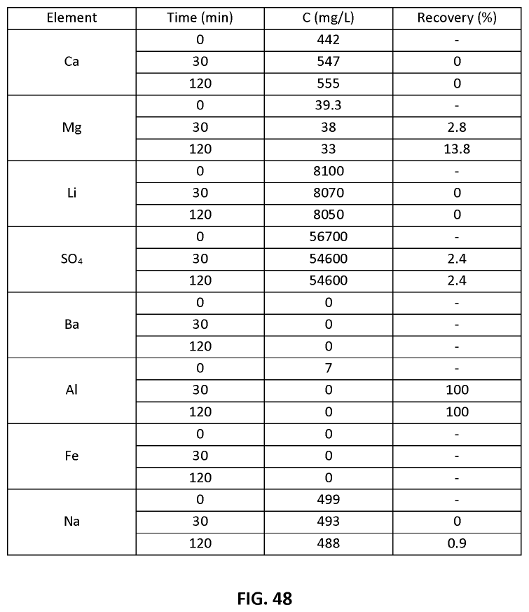

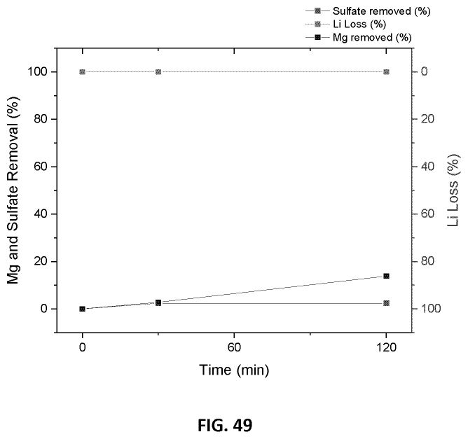

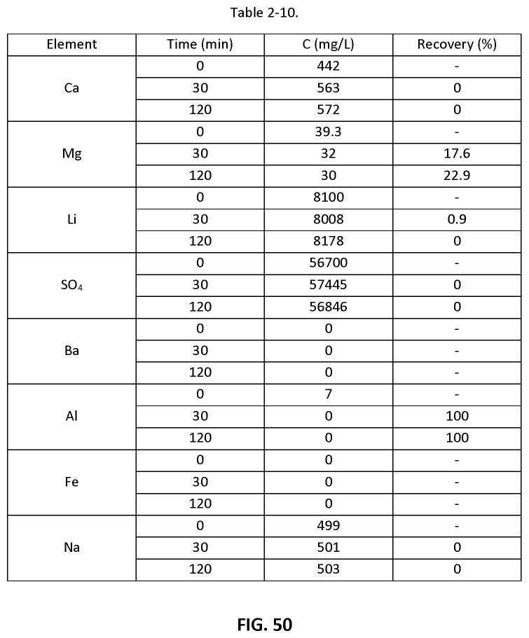

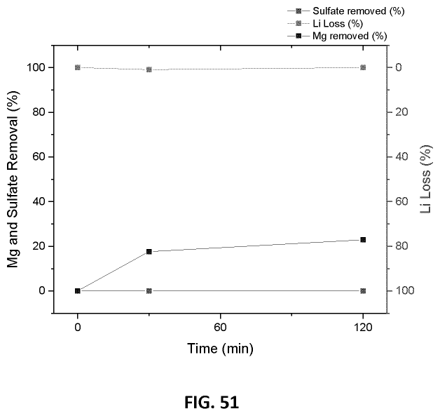

To explore the effects of various process parameters in this step, a precipitation pH range of about 7 to about 10, temperatures from 25 to 85° C. and lime pulp densities of 1, 5 and 10% were tested. Good process performances were observed at a precipitation pH of about 10, a lime pulp density of 5% and a temperature of about 65° C. An indicator of process performance was the % Mg removal. Test conditions and product compositions are shown in Tables 2-1 and 2-2, and FIGS. 6 and 7. FIG. 7 presents the XRD of the final solid residue, confirming gypsum and excess lime are the only major solids present in the residue, confirming a clean gypsum. Based on Table 2-2 and FIG. 5, all Mg in the PLS was precipitated as Mg(OH)₂ in the solid residue and insignificant amounts of Li were precipitated as Li₂O₄ in the solid residue. See also FIGS. 30-51.

TABLE 2-1
Mg removal test conditions

| | Parameters | | | |
|---|---|---|---|---|
| | Terminal | Lime slurry | T | Kinetic |
| Test # | pH | PD | (° C.) | samples? |
| 2-1 | 7 | 5% | 25 | Yes |
| 2-2 | 8 | 5% | 25 | Yes |
| 2-3 | 9 | 5% | 25 | Yes |
| 2-4 | 9.5 | 5% | 25 | Yes |
| 2-5 | 10 | 5% | 25 | Yes |
| 2-6 | 10 | 5% | 45 | Yes |
| 2-7 | 10 | 5% | 65 | Yes |
| 2-8 | 10 | 5% | 85 | Yes |
| 2-9 | 10 | 1% | 25 | Yes |
| 2-10 | 10 | 10% | 25 | Yes |

TABLE 2-2
Concentration of the elements in kinetic samples at pH =
10 and CaO = 5% at T = 65° C.

| | Time | C | Recovery |
|---|---|---|---|
| Element | (min) | (mg/L) | (%) |
| Ca | 0 | 442 | — |
| | 30 | 602 | 0 |
| | 120 | 590 | 0 |
| Mg | 0 | 41.7 | — |
| | 30 | 0 | 100 |
| | 120 | 0 | 100 |
| Li | 0 | 8100 | — |
| | 30 | 8000 | 98.8 |
| | 120 | 7970 | 98.4 |
| SO₄ | 0 | 56700 | — |
| | 30 | 54300 | 2 |
| | 120 | 57722 | 0 |
| Ba | 0 | 0 | — |
| | 30 | 0 | — |
| | 120 | 0 | — |
| Al | 0 | 7 | — |
| | 30 | 0 | 100 |
| | 120 | 0 | 100 |
| Fe | 0 | 0 | — |
| | 30 | 0 | — |
| | 120 | 0 | — |
| Na | 0 | 499 | — |
| | 30 | 492 | 1.4 |
| | 120 | 500 | 0 |

### Example 3—Ca Removal from PLS Using Na₂CO₃

This step comprised treating the PLS with Na₂CO₃ (Ca removal step) at room temperature (22° C.) using solid Na₂CO₃ to precipitate Ca as CaCO₃ crystals. The expected reactions in this step are:

$$C a S {O}_{4 ( aq )} + N {a}_{2} C {O}_{3} = C a C {O}_{3 ( solid )} + N {a}_{2} S {O}_{4 ( aq )} ( dominant reaction )$$

$$L {i}_{2} S {O}_{4} + N {a}_{2} C {O}_{3} = L {i}_{2} C {O}_{3 ( solid )} + N {a}_{2} S {O}_{4 ( aq )} ( side reaction - not significant )$$

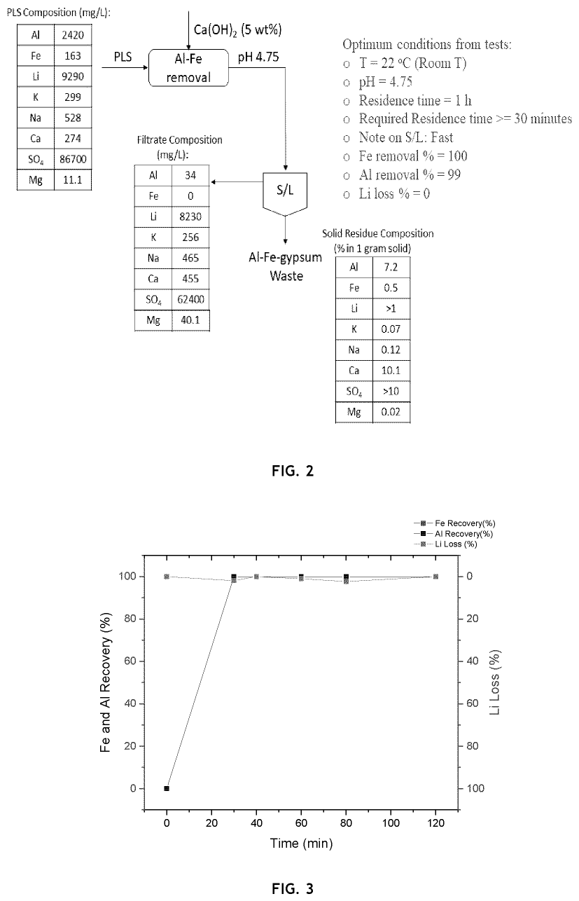

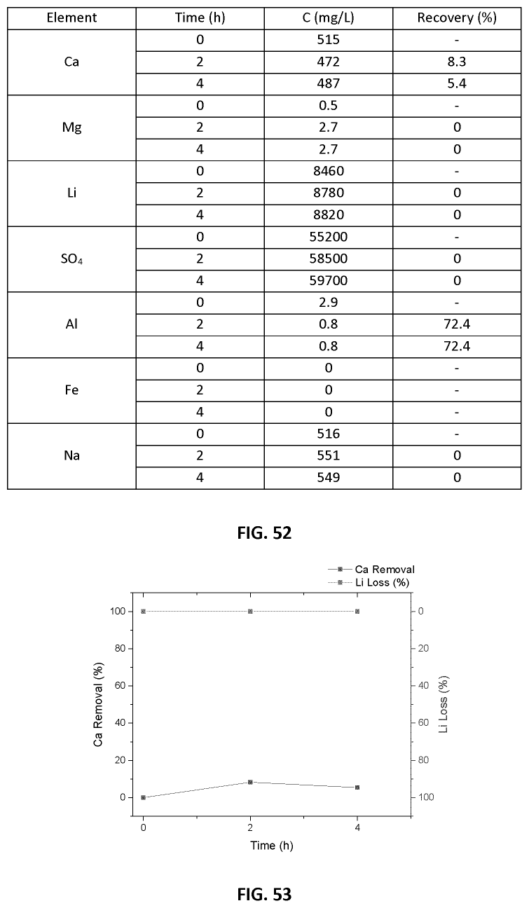

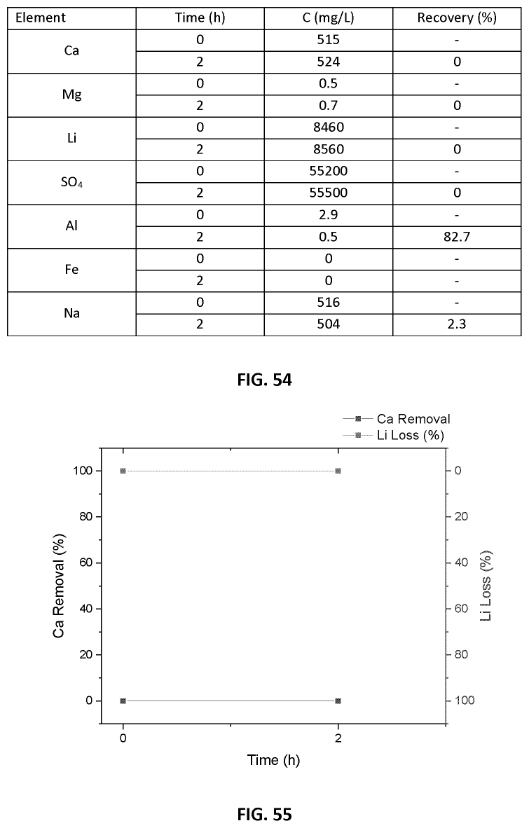

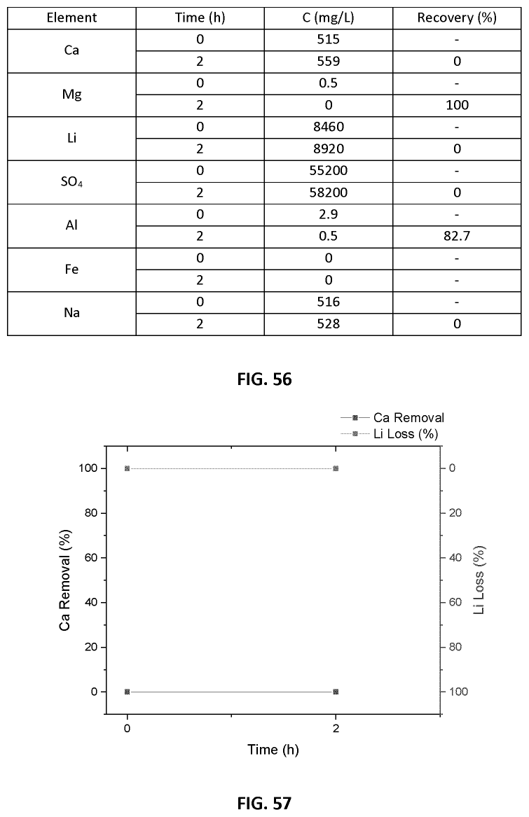

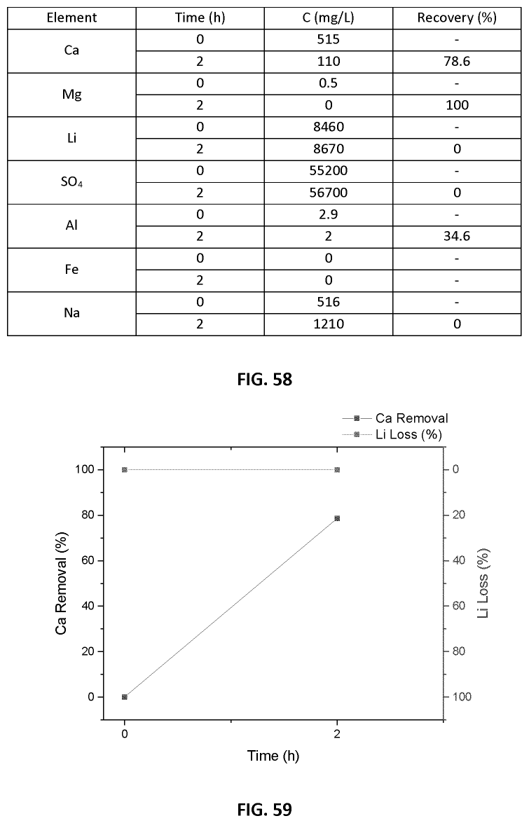

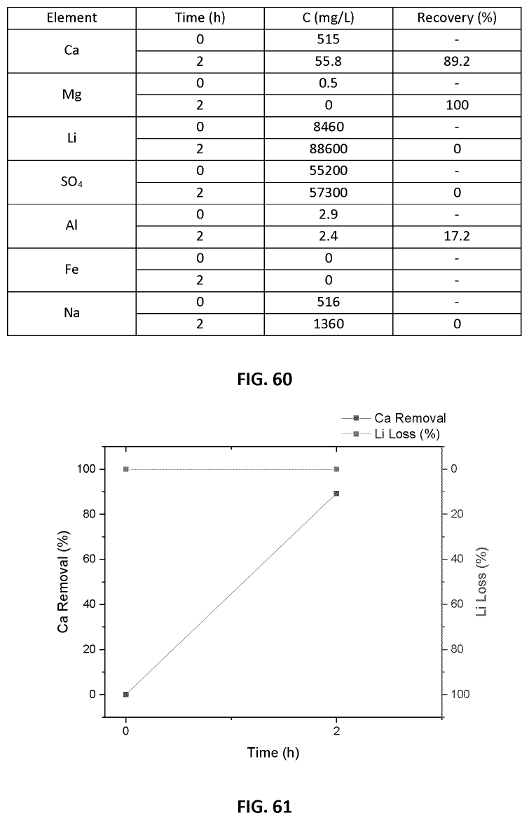

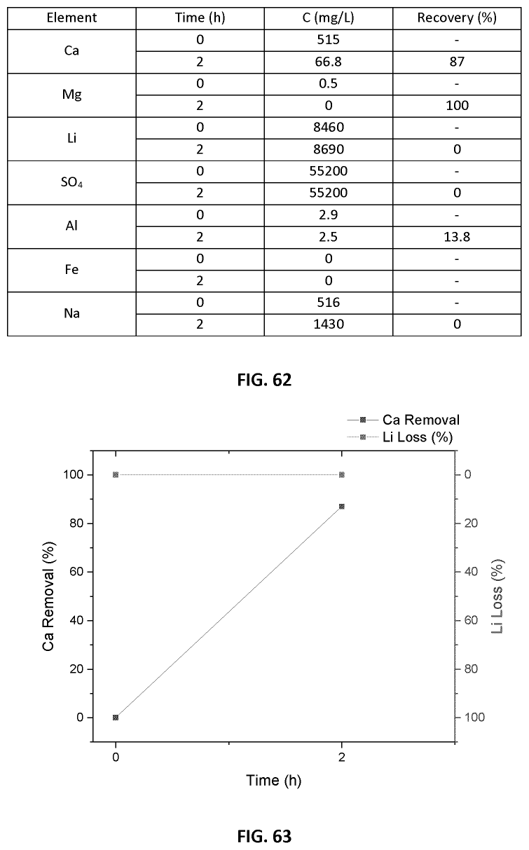

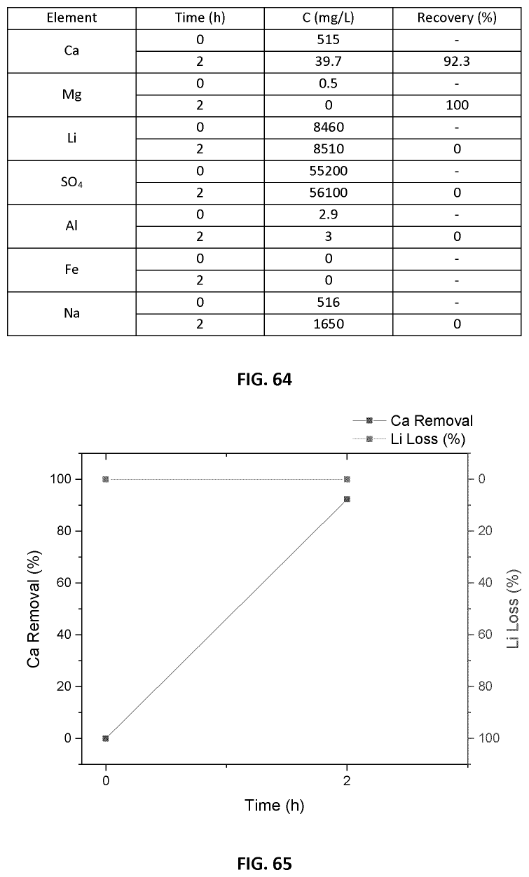

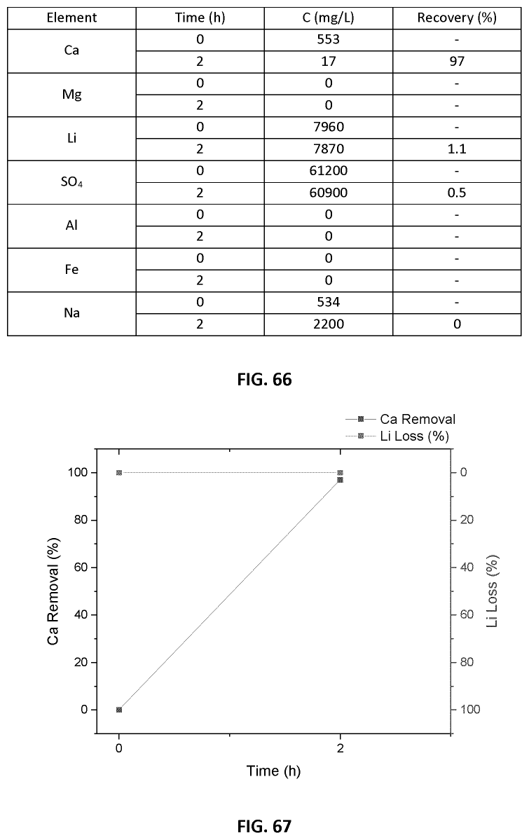

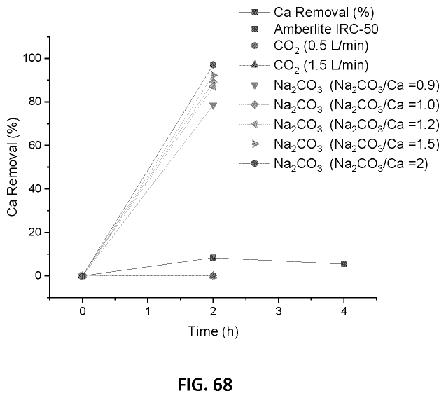

Good process performances were observed at 22° C., pH of 11 (automatically adjusts to this pH), residence time of 2 hours or less, and CO₂ to Ca molar ratio of 2 (200% stoichiometric requirement). 97% of Ca in the solution was removed by Na₂CO₃ and precipitated as CaCO₃ in the solid residue. Further test conditions and product compositions are shown in Tables 3-1 and 3-2, and FIG. 3-2. It should be noted that Amberlite IRC 50 resin and CO₂ gas addition were also tested, but none were as efficient as the addition of sodium carbonate for calcium removal. See also FIGS. 52-68.

TABLE 3-1
Ca removal test conditions

| | Parameters | | | |
|---|---|---|---|---|
| Test | | Resin or | CO₂ to Ca | Kinetic |
| # | pH | reagent | ratio | samples? |
| 3-1 | 10 | Amberlite | — | Yes |
| | | IRC 50 | | |
| 3-2 | 10 | CO₂ | 0.5 (L/min) | Yes |
| 3-3 | 10 | CO₂ | 1.5 (L/min) | Yes |
| 3-4 | 10 | Na₂CO₃ | 0.9 | Yes |
| 3-5 | 10 | Na₂CO₃ | 1.0 | Yes |
| 3-6 | 10 | Na₂CO₃ | 1.2 | Yes |
| 3-7 | 10 | Na₂CO₃ | 1.5 | Yes |
| 3-8 | 10 | Na₂CO₃ | 2 | Yes |

TABLE 3-2
Concentration of the elements in kinetic samples
at Na₂CO₃/Ca = 2 and room temperature.

| | Time | C | Recovery |
|---|---|---|---|
| Element | (h) | (mg/L) | (%) |
| Ca | 0 | 553 | — |
| | 2 | 17 | 97 |
| Mg | 0 | 0 | — |
| | 2 | 0 | — |
| Li | 0 | 7960 | — |
| | 2 | 7870 | 1.1 |
| SO₄ | 0 | 61200 | — |
| | 2 | 60900 | 0.5 |
| Al | 0 | 0 | — |
| | 2 | 0 | — |
| Fe | 0 | 0 | — |
| | 2 | 0 | — |
| Na | 0 | 534 | — |
| | 2 | 2200 | 0 |

### Example 4—Sulfate removal from PLS using BaCl₂

This step comprised treating the solution following the “Ca removal step” with BaCl₂ (sulfate removal step) to precipitate sulfate as barium sulfate crystals and produce LiCl liquor (e.g., a clean LiCl solution). The expected reaction in this step is:

$$L {i}_{2} S {O}_{4} + B a C {l}_{2} = B a S {O}_{4 ( solid )} + 2 L i C {l}_{( aq )}$$

In this step a final pH ranging from about 7 to about 11.5, a temperature ranging from 25 to 65° C., a Ba/sulfate stoichiometric ratio ranging from about 0.95 to about 1.10 was tested. Good process performances were observed at a pH near 9 (the natural PH of the solution was around 11; pH adjustment was done using sulfuric acid), 25° C., and Ba/sulfate ratio of 1.05 when using high a purity barium chloride salt.

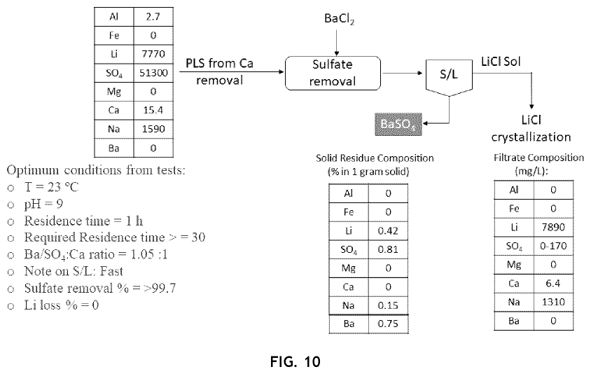

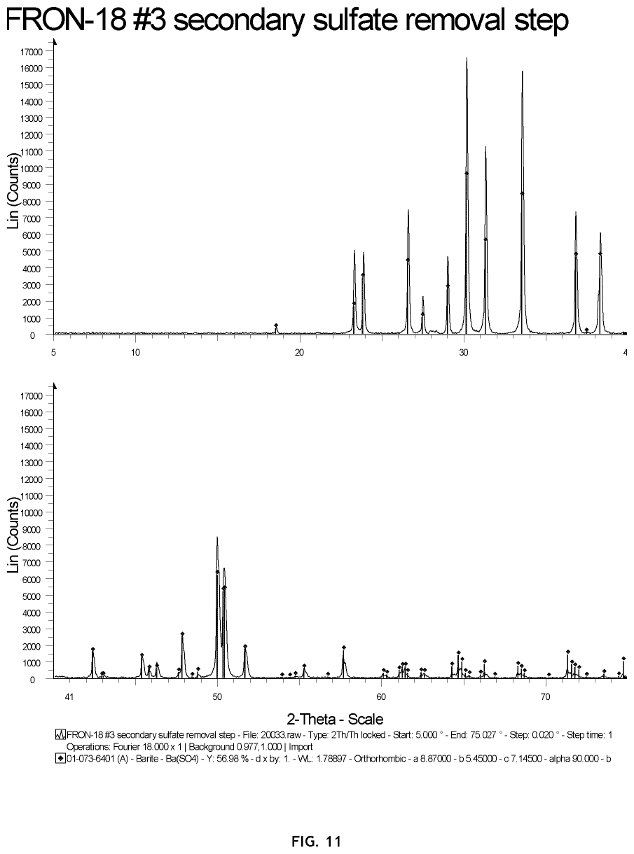

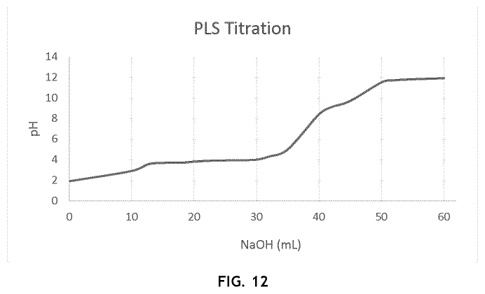

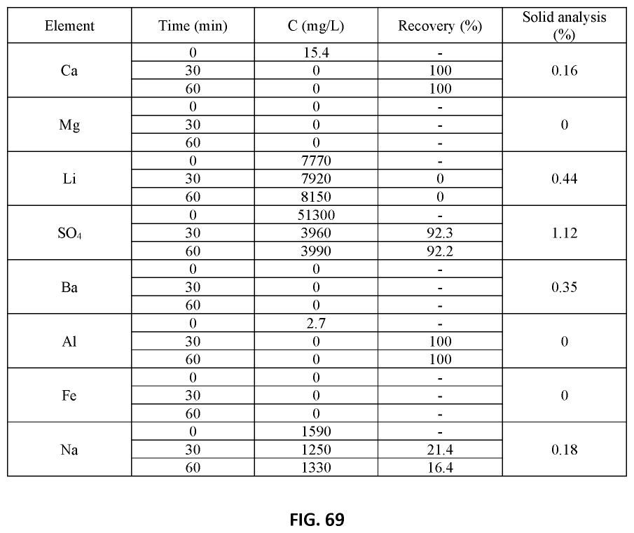

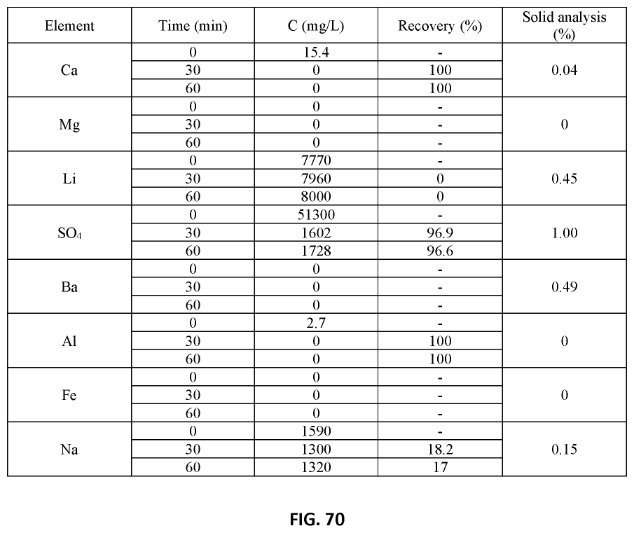

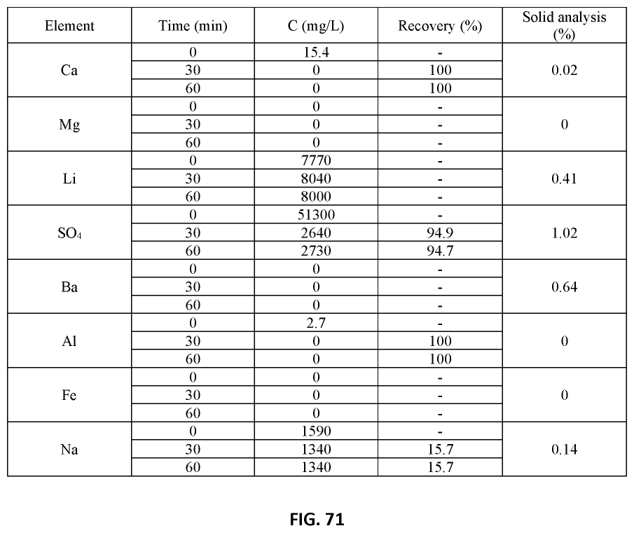

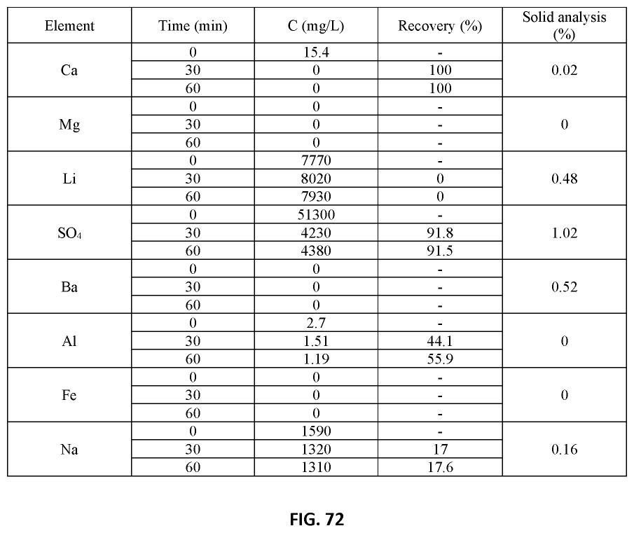

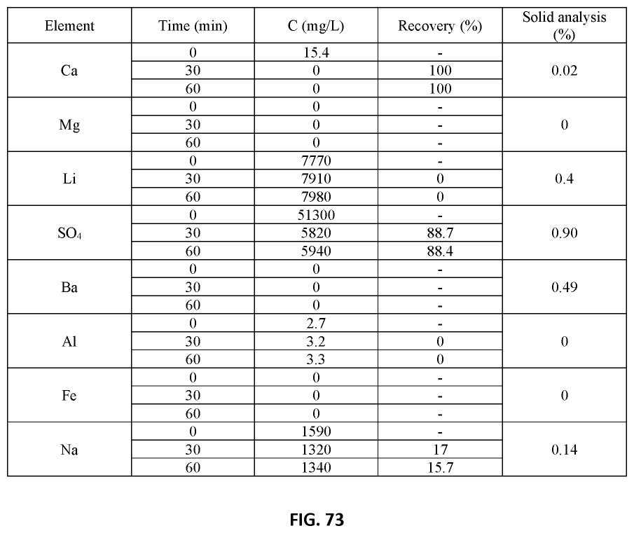

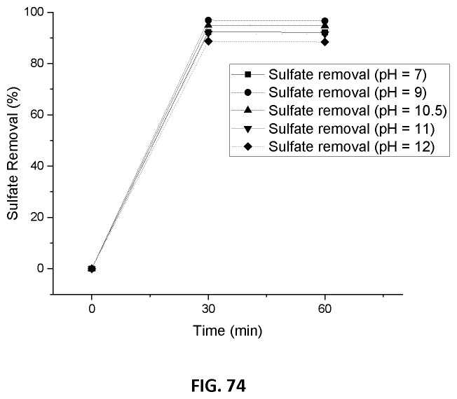

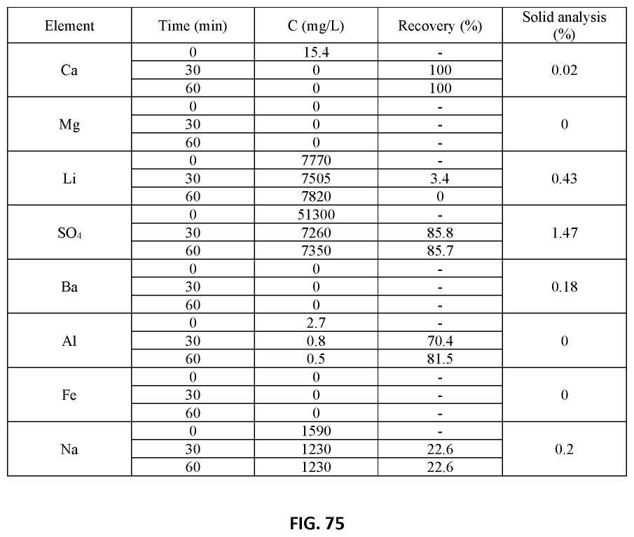

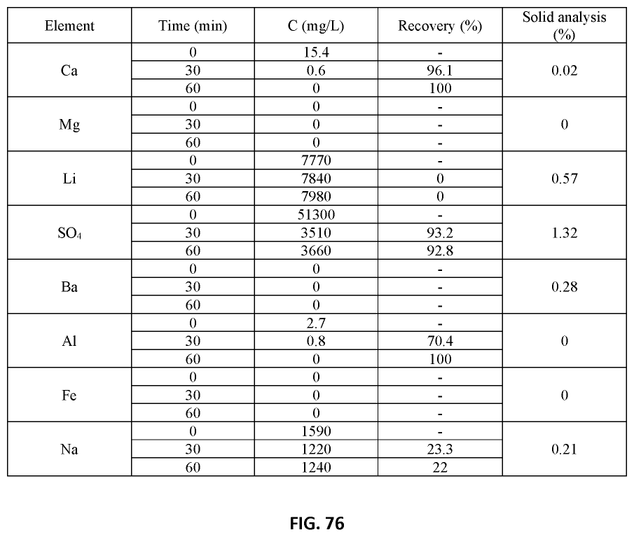

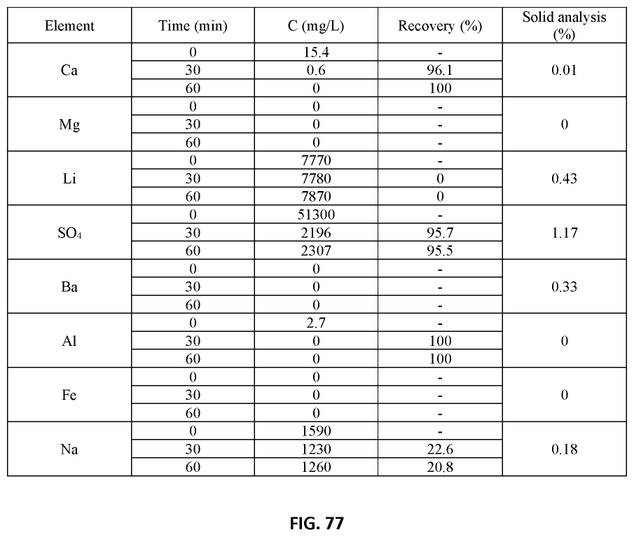

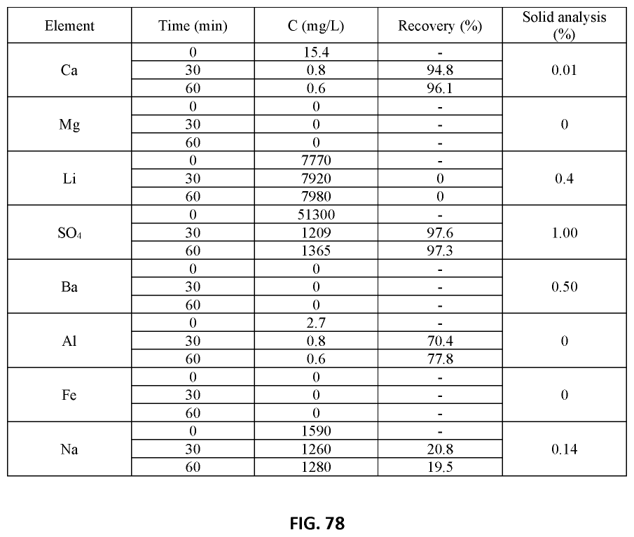

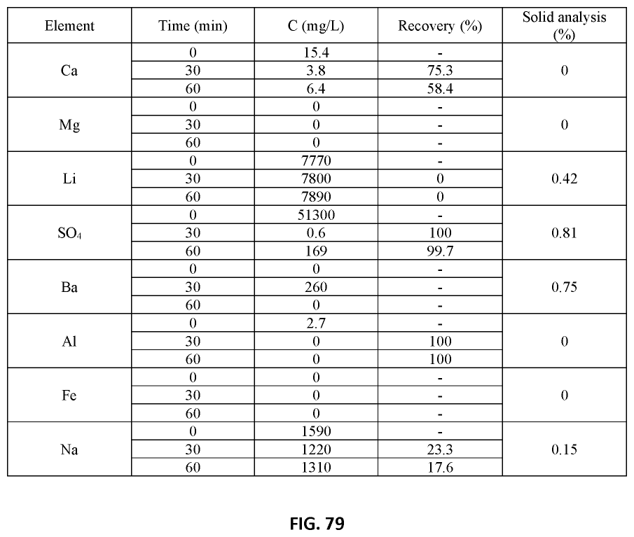

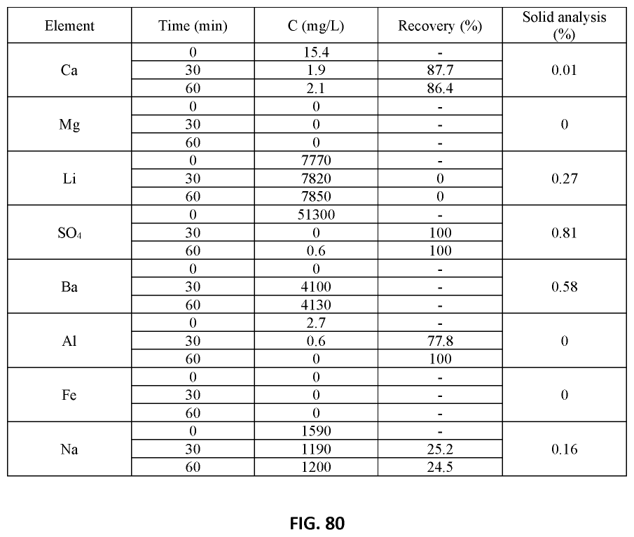

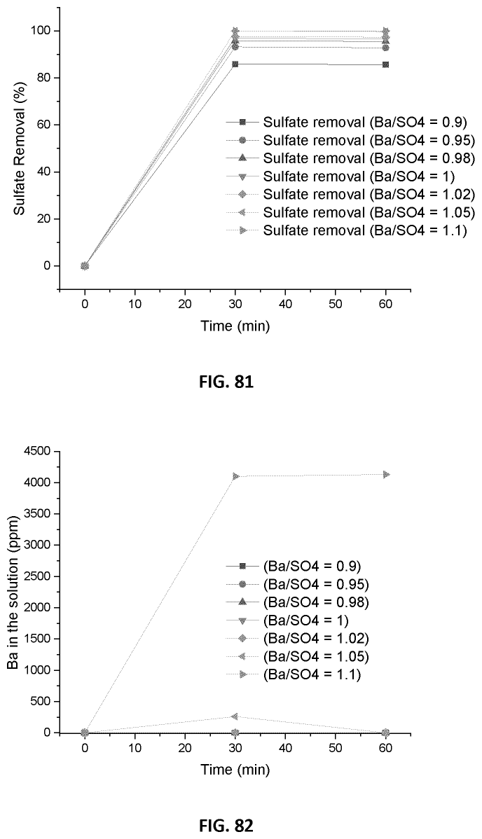

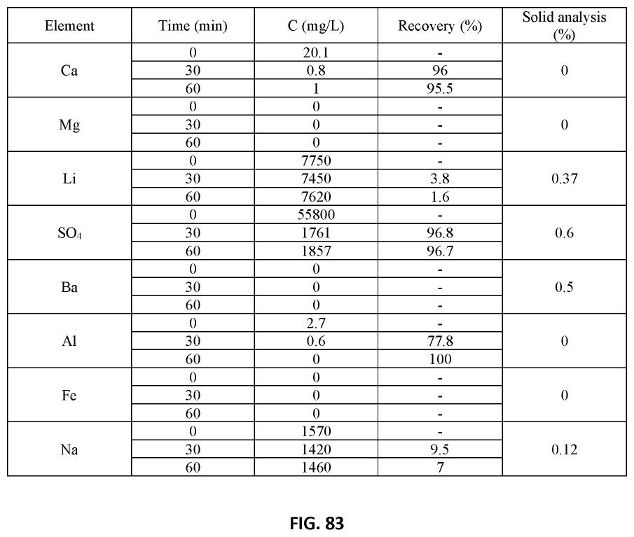

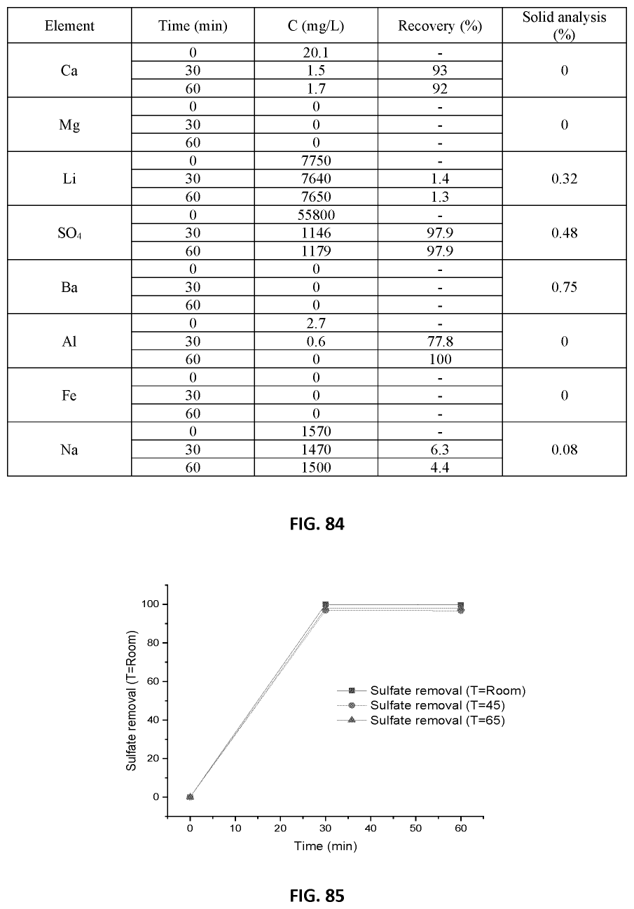

Further test conditions and product compositions are shown in Tables 4-1 and 4-2, and FIGS. 10 and 11. FIG. 11 presents the XRD of the final solid residue, confirming that barium sulfate is the major solid present in the residue. See also FIGS. 69-85.

TABLE 4-1
Li₂CO₃ crystallization step
Secondary sulfate removal tests - test duration: 1 h

| | Parameters | | | | |
|---|---|---|---|---|---|
| | Terminal | | Ba to SO₄ | T | Kinetic |
| Test # | pH | Ba salt | molar ratio | (° C.) | samples? |
| LiCl-4-1 | 7.0 | BaCl₂ | 1.00 | 25 | Yes |
| LiCl-4-2 | 9.0 | BaCl₂ | 1.00 | 25 | Yes |
| LiCl-4-3 | 10.0 | BaCl₂ | 1.00 | 25 | Yes |
| LiCl-4-4 | 11.0 | BaCl₂ | 1.00 | 25 | Yes |
| LiCl-4-5 | 12.0 | BaCl₂ | 1.00 | 25 | Yes |
| LiCl-4-6 | Opt. pH | BaCl₂ | 0.90 | 25 | Yes |
| LiCl-4-7 | Opt. pH | BaCl₂ | 0.95 | 25 | Yes |
| LiCl-4-8 | Opt. pH | BaCl₂ | 0.98 | 25 | Yes |
| LiCl-4-9 | Opt. pH | BaCl₂ | 1.02 | 25 | Yes |
| LiCl-4-10 | Opt. pH | BaCl₂ | 1.05 | 25 | Yes |
| LiCl-4-11 | Opt. pH | BaCl₂ | 1.10 | 25 | Yes |
| LiCl-4-12 | Opt. pH | BaCl₂ | Opt. ratio | 45 | Yes |
| LiCl-4-13 | Opt. pH | BaCl₂ | Opt. ratio | 65 | Yes |
| LiCl-4-14 | 9 | BaCl₂ | 1.05 | 25 | Yes |

TABLE 4-2
Concentration of elements in kinetic samples at pH =
9 and Ba/SO₄ = 1.05 at room temperature.

| | | | | Solid |
|---|---|---|---|---|
| | Time | C | Recovery | analysis |
| Element | (min) | (mg/L) | (%) | (%) |
| Ca | 0 | 15.4 | — | 0 |
| | 30 | 3.8 | 75.3 | |
| | 60 | 6.4 | 58.4 | |
| Mg | 0 | 0 | — | 0 |
| | 30 | 0 | — | |
| | 60 | 0 | — | |
| Li | 0 | 7770 | — | 0.42 |
| | 30 | 7800 | 0 | |
| | 60 | 7890 | 0 | |
| SO₄ | 0 | 51300 | — | 0.81 |
| | 30 | 0.6 | 100 | |
| | 60 | 169 | 99.7 | |
| Ba | 0 | 0 | — | 0.75 |
| | 30 | 260 | — | |
| | 60 | 0 | — | |
| Al | 0 | 2.7 | — | 0 |
| | 30 | 0 | 100 | |
| | 60 | 0 | 100 | |
| Fe | 0 | 0 | — | 0 |
| | 30 | 0 | — | |
| | 60 | 0 | — | |
| Na | 0 | 1590 | — | 0.15 |
| | 30 | 1220 | 23.3 | |
| | 60 | 1310 | 17.6 | |

All of the processes and process steps disclosed and claimed herein can be made and executed without undue experimentation in light of the present disclosure. While the processes and process steps of this disclosure have been described in terms of preferred embodiments, it will be apparent to those of skill in the art that variations may be applied to the processes and process steps described herein without departing from the concept, spirit and scope of the disclosure. All such variations apparent to those skilled in the art are deemed to be within the spirit, scope and concept of the disclosure as defined by the appended claims.

1. A process for recovering lithium chloride from an initial aqueous solution comprising lithium sulfate (Li₂SO₄), the process comprising:
increasing the pH of the initial Li₂SO₄-comprising aqueous solution to reduce the level of species of one or more metals other than lithium and to remove sulfate;
treating the solution after the reducing of the one or more metals other than lithium and the removal of sulfate with a material to remove calcium and to produce a solution substantially comprising Li₂SO₄;
treating the solution substantially comprising Li₂SO₄ with barium chloride (BaCl₂) to form a precipitate comprising barium sulfate (BaSO₄) and a solution substantially comprising lithium chloride; and
recovering the lithium chloride (LiCl) from the solution following BaSO₄ precipitation;
wherein the aqueous solution comprising lithium sulfate (Li₂SO₄) is derived from a natural source or mineral deposit comprising a lithium species or from a synthetic or non-natural source comprising a lithium species.

2. The process of claim 1, wherein the lithium chloride is recovered in the form of lithium chloride or a hydrate thereof.

3. The process of claim 1 or 2, wherein the initial aqueous solution comprising lithium sulfate is derived from a natural source or mineral deposit comprising a lithium species.

4. The process of any one of claims 1 to 3, wherein the natural source or mineral deposit comprising the lithium species is an ore, clay or brine.

5. The process of any one of claims 1 to 4, wherein the natural source or mineral deposit comprising the lithium species is not a sulfide ore body.

6. The process of claim 4 or 5, wherein the ore or clay comprises lepidolite, hectorite, jaderite, spodumene, petalite and/or amblygonite.

7. The process of claim 4 or 5, wherein the brine comprises continental brine, geothermal brine and/or oilfield brine.

8. The process of claim 1 or 2, wherein the aqueous solution comprising lithium sulfate is derived from a synthetic or non-natural source comprising a lithium species.

9. The process of claim 8, wherein the synthetic or non-natural source comprising the lithium species comprises materials produced during recycling of lithium-ion batteries or other lithium bearing materials.

10. The process of claim 9, wherein the materials produced during recycling of lithium-ion batteries comprise lithium-ion battery electrode materials.

11. The process of claim 9 or 10, wherein the materials produced during recycling of lithium-ion batteries and/or lithium-ion battery electrode materials comprise lithium cobalt oxide, lithium manganese oxide, lithium iron phosphate, and/or lithium nickel manganese cobalt oxide.

12. The process of any one of claims 1 to 11, further comprising producing the initial Li₂SO₄-comprising aqueous solution via treatment of a metal-comprising mixture with sulfuric acid (H₂SO₄).

13. The process of claim 12, wherein the metal-comprising mixture is the natural source or mineral deposit comprising the lithium species or the synthetic or non-natural source comprising the lithium species, or is a derivative of the natural source or mineral deposit comprising the lithium species or the synthetic or non-natural source comprising the lithium species.

14. The process of claim 12 or 13, wherein the metal-comprising mixture comprises lithium oxide (Li₂O).

15. The process of any one of claims 1 to 14, wherein the initial Li₂SO₄-comprising aqueous solution has a pH of about 4.0 or less.

16. The process of claim 15, wherein the initial Li₂SO₄-comprising aqueous solution has a pH of about 2.0 to about 3.0.

17. The process of any one of claims 1 to 16, wherein the initial Li₂SO₄-comprising aqueous solution further comprises one or more metal sulfates of one or more metals other than lithium.

18. The process of any one of claims 12 to 17, wherein the metal-comprising mixture further comprises one or more metals other than lithium.

19. The process of claim 17 or 18, wherein the one or more metals other than lithium are one or more of Group I metals (other than lithium), Group Il metals, transition metals and/or post-transition metals.

20. The process of any one of claims 17 to 19, wherein the one or more metals other than lithium are one or more of calcium, sodium, magnesium, potassium, aluminum and iron.

21. The process of any one of claims 1 to 20, wherein the pH of the initial Li₂SO₄-comprising aqueous solution is increased to about 3.0 or higher.

22. The process of claim 21, wherein the pH of the initial Li₂SO₄-comprising aqueous solution is increased to about 4.0 to about 5.5.

23. The process of claim 21 or 22, wherein the pH of the initial Li₂SO₄-comprising aqueous solution is increased to about 7.0 or higher.

24. The process of claim 23, wherein the pH of the initial Li₂SO₄-comprising aqueous solution is increased to be about 9.0 to about 12.0.

25. The process of any one of claims 1 to 24, wherein the reducing the level of species of the one or more metals other than lithium by increasing the pH of the initial Li₂SO₄-comprising aqueous solution is performed in single step.

26. The process of claim 25, wherein the single step comprises increasing the pH of the initial Li₂SO₄-comprising aqueous solution to be about 3.0 or higher.

27. The process of claim 26, wherein the pH of the initial Li₂SO₄-comprising aqueous solution is increased to about 4.0 to about 5.5.

28. The process of claim 25, wherein the single step comprises increasing the pH of the initial Li₂SO₄-comprising aqueous solution to about 7.0 or higher.

29. The process of claim 28, wherein the pH of the initial Li₂SO₄-comprising aqueous solution is increased to about 9.0 to about 12.0.

30. The process of any one of claims 1 to 24, wherein the reducing the level of species of the one or more metals other than lithium by increasing the pH of the initial Li₂SO₄-comprising aqueous solution comprises multiple steps.

31. The process of claim 30, wherein the multiple steps comprise a first step of increasing the pH of the initial Li₂SO₄-comprising aqueous solution to a pH of about 3.0 or higher to produce a first Li₂SO₄-comprising aqueous solution comprising reduced levels of metals other than lithium, followed by increasing the pH of the first Li₂SO₄-comprising aqueous solution to a pH of about 7.0 or higher to produce a second Li₂SO₄-comprising aqueous solution comprising further reduced levels of metals other than lithium.

32. The process of any one of claims 1 to 31, wherein increasing the pH of the initial Li₂SO₄-comprising aqueous solution comprises treating with an alkaline material.

33. The process of claim 32, wherein the alkaline material comprises lime.

34. The process of claim 33, wherein the lime is in the form of a lime slurry or solid lime powder.

35. The process of any one of claims 1 to 34, wherein calcium removal comprises treating with a carbonate source to form a precipitate comprising one or more metal carbonates, wherein the lithium species is recovered from the solution remaining after precipitation of the one or more metal carbonates.

36. The process of claim 35, wherein the carbonate source is a carbonate salt or CO₂ gas.

37. The process of claim 36, wherein the carbonate salt is at least one of sodium carbonate (Na₂CO₃) or lithium carbonate (Li₂CO₃).

38. The process of any one of claims 35 to 37, wherein the one or more metal carbonates are one or more of calcium carbonate and magnesium carbonate.

39. The process of any one of claims 25 to 31, wherein increasing the pH comprises treating the initial Li₂SO₄-comprising aqueous solution with one or more calcium salts.

40. The process of claim 39, wherein the treatment of the Li₂SO₄-comprising aqueous solution with the one or more calcium salts produces a precipitate comprising calcium sulfate (CaSO₄).

41. The process of claim 40, wherein the precipitate further comprises magnesium and/or base metal oxides and/or hydroxides.

42. The process of any one of claims 1 to 41, wherein the treatment with barium chloride to form a precipitate comprising barium sulfate is performed at a pH of about 6.0 or higher.

43. The process of claim 42, wherein the treatment with barium chloride to form a precipitate comprising barium sulfate is performed at a pH of about 9.0 to about 12.0.

44. The process of any one of claims 1 to 43, wherein the barium chloride is added at a molar ratio of barium to sulfate of about 0.1 to about 3.0.

45. The process of claim 44, wherein the barium chloride is added at a molar ratio of barium to sulfate of about 0.8 to about 1.5.

46. The process of claim 45, wherein the barium chloride is added at a molar ratio of barium to sulfate of about 0.95 to about 1.1.

47. The process of any one of claims 1 to 46, wherein the lithium chloride is recovered by crystallization from the aqueous solution.

48. The process of claim 47, comprising at least one of heat treatment or subjecting the aqueous solution to reduced pressure to remove at least a part of the water from the aqueous solution.

49. The process of claim 48, wherein at least about 10% of the water is removed.

50. The process of claim 49, wherein at least about 15% of the water is removed.

51. The process of any one of claims 1 to 50, wherein the recovered lithium species is a hydrate of LiCl.

52. The process of any one of claims 1 to 51, further comprising subjecting the BaSO₄ to a treatment to generate barium salts including barium oxide, barium hydroxide or barium carbonate and to recover sulfur as sodium sulfide, sodium hydrosulfide, sulfuric acid, or elemental sulfur.

53. The process of claim 51 or 52, further comprising subjecting SO₃ to water treatment to form H₂SO₄.

54. The process of claim 53, wherein the H₂SO₄ is used for treating the metal-comprising mixture of claim 12.

55. The process of any one of claims 1 to 54, wherein the solution substantially comprising Li₂SO₄ is treated with barium chloride at a pH of at least about 6, at least about 7, about 6 to about 12, about 7 to about 12, about 8 to about 12, about 9 to about 12, about 10 to about 12, about 6, about 7, about 8, about 9, about 10, about 11, or about 12.

56. The process of claim 39 or 40, wherein treating with the one or more calcium salts is performed at a pH of at least about 3, at least about 4, at least about 5, at least about 6, at least about 7, about 3 to about 12, about 4 to about 12, about 5 to about 12, about 6 to about 12, about 7 to about 12, about 8 to about 12, about 9 to about 12, about 10 to about 12, about 3, about 4, about 5, about 6, about 7, about 8, about 9, about 10, about 11, or about 12.

57. The process of claim 56, wherein treating with the one or more calcium salts is performed at a molar ratio of calcium to sulfate of about 80% to about 120%, about 90% to about 120%, about 100% to about 120%, about 90% to about 110%, about 80%, about 90%, about 100%, about 110% or about 120%.

58. The process of any one of claims 1 to 57, wherein the solution comprising substantially Li₂SO₄, is treated with barium chloride at a molar ratio of barium to sulfate of about 10% to about 300%, about 80% to about 150%, about 80% to about 120%, about 90% to about 120%, about 100% to about 120%, about 90% to about 110%, about 95% to about 110%, about 80%, about 90%, about 100%, about 110% or about 120%.

59. The process of any one of claims 1 to 58, wherein the solution substantially comprising Li₂SO₄ is treated with barium chloride at a temperature of about 1° C. to about 100° C., about 5° C. to about 75° C., about 5° C. to about 60° C., about 10° C. to about 60° C., about 15° C. to about 60° C., about 20° C. to about 60° C., or at room temperature.

60. The process of any one of claims 35 to 38, wherein the treatment with the carbonate source is performed at a molar ratio of carbonate to the one or more metals of about 80% to about 120%, about 90% to about 120%, about 100% to about 120%, about 90% to about 110%, about 80%, about 90%, about 100%, about 110% or about 120%.

61. The process of any one of claims 1 to 60, wherein the concentration of lithium in the initial aqueous solution comprising lithium sulfate (Li₂SO₄) is about 1 to about 25 g/L, about 5 to about 25 g/L, about 5 to about 20 g/L, about 5 to about 15 g/L, about 8 to about 12 g/L, about 5 g/L, about 6 g/L, about 7 g/L, about 8 g/L, about 9 g/L, about 10 g/L, about 11 g/L, about 12 g/L, about 13 g/L, about 14 g/L, or about 15 g/L.

62. The process of any one of claims 1 to 61, wherein at least about 50%, 55%, 60%, 65%, 70%, 75%, 80%, 90%, 95% or 99% of the lithium is recovered from the initial aqueous solution comprising lithium sulfate.

63. The process of any one of claims 1 to 62, wherein about 50% to about 99%, about 55% to about 99%, about 60% to about 99%, about 65% to about 99%, about 70% to about 99%, about 75% to about 99%, about 80% to about 99%, or about 90% to about 99% of the lithium is recovered from the initial aqueous solution comprising lithium sulfate.

64. A process for recovering lithium chloride from a material comprising a lithium species and species of one or more metals other than lithium, the process comprising:
treating the material with sulfuric acid (H₂SO₄) to provide an initial Li₂SO₄-comprising aqueous solution;
increasing the pH of the initial Li₂SO₄-comprising aqueous solution to reduce the level of species of one or more metals other than lithium and to remove sulfate;
treating the solution after the reducing of the one or more metals other than lithium and the removal of sulfate with a material to remove calcium and to produce a solution substantially comprising Li₂SO₄;
treating the solution substantially comprising Li₂SO₄ with barium chloride to form a precipitate comprising barium sulfate and a solution substantially comprising lithium chloride; and
recovering the lithium chloride from the solution remaining following the removal of the barium sulfate comprising precipitate in the form of lithium chloride or a hydrate thereof, via heat treatment and crystallization.

65. The process of claim 64, wherein the reducing the level of species of the one or more metals other than lithium by increasing the pH of the initial Li₂SO₄-comprising aqueous solution is performed in single step.

66. The process of claim 65, wherein the single step comprises increasing the pH of the initial Li₂SO₄-comprising aqueous solution to be about 3.0 or higher.

67. The process of claim 66, wherein the pH of the initial Li₂SO₄-comprising aqueous solution is increased to about 4.0 to about 5.5.

68. The process of claim 67, wherein the single step comprises increasing the pH of the initial Li₂SO₄-comprising aqueous solution to about 7.0 or higher.

69. The process of claim 68, wherein the pH of the initial Li₂SO₄-comprising aqueous solution is increased to about 9.0 to about 12.0.

70. The process of claim 64, wherein the reducing the level of species of the one or more metals other than lithium by increasing the pH of the initial Li₂SO₄-comprising aqueous solution comprises multiple steps.

71. The process of claim 70, wherein the multiple steps comprise a first step of increasing the pH of the initial Li₂SO₄-comprising aqueous solution to a pH of about 3.0 or higher to produce a first Li₂SO₄-comprising aqueous solution comprising reduced levels of metals other than lithium, followed by increasing the pH of the first Li₂SO₄-comprising aqueous solution to a pH of about 7.0 or higher to produce a second Li₂SO₄-comprising aqueous solution comprising further reduced levels of metals other than lithium.

72. The process of any one of claims 64 to 71, wherein increasing the pH of the initial Li₂SO₄-comprising aqueous solution comprises treating with an alkaline material.

73. The process of claim 72, wherein the alkaline material comprises lime.

74. The process of claim 73, wherein the lime is in the form of a lime slurry or solid lime powder.

75. The process of any one of claims 64 to 74, wherein calcium removal comprises treating with a carbonate source to form a precipitate comprising one or more metal carbonates, wherein the lithium species is recovered from the solution remaining after precipitation of the one or more metal carbonates.

76. The process of claim 75, wherein the carbonate source is a carbonate salt or CO₂ gas.

77. The process of claim 76, wherein the carbonate salt is at least one of sodium carbonate (Na₂CO₃) or lithium carbonate (Li₂CO₃).

78. The process of any one of claims 75 to 77, wherein the one or more metal carbonates are one or more of calcium carbonate and magnesium carbonate.

79. The process of any one of claims 64 to 71, wherein increasing the pH comprises treating the initial Li₂SO₄-comprising aqueous solution with one or more calcium salts.

80. The process of any one of claims 64 to 79, wherein the material is obtained from a natural source or mineral deposit comprising lithium species.

81. The process of claim 80, wherein the natural source is an ore, clay, brine or other mineral deposit.

82. The process of claim 81, wherein the ore or clay comprises lepidolite, hectorite, jaderite, spodumene, petalite and/or amblygonite.

83. The process of any one of claims 80 to 82, wherein the natural source or mineral deposit comprising lithium species is not a sulfide ore body.

84. The process of claim 81, wherein the brine comprises continental brine, geothermal brine and/or oilfield brine.

85. The process of any one of claims 64 to 79, wherein the material is obtained from a synthetic or non-natural source comprising lithium species.

86. The process of claim 85, wherein the synthetic or non-natural source comprising lithium species comprises materials produced during recycling of lithium-ion batteries or other lithium bearing materials.

87. The process of claim 86, wherein the materials produced during recycling of lithium-ion batteries comprise lithium-ion battery electrode materials.

88. The process of claim 87, wherein the lithium-ion battery electrode materials comprise lithium cobalt oxide, lithium manganese oxide, lithium iron phosphate, and/or lithium nickel manganese cobalt oxide.
